(19) United States
(12) Patent Application Publication
(10) Pub. No.: US 2021/0201359 A1
(43) Pub. Date: Jul. 1, 2021

(54) SYSTEMS AND METHODS RELATING TO AUTOMATION FOR PERSONALIZING THE CUSTOMER EXPERIENCE

(71) Applicant: GENESYS TELECOMMUNICATIONS LABORATORIES, INC., Daly City, CA (US)

(72) Inventors: ARCHANA SEKAR, CHENNAI (IN); YOCHAI KONIG, SAN FRANCISCO, CA (US)

(73) Assignee: GENESYS TELECOMMUNICATIONS LABORATORIES, INC., DALY CITY, CA (US)

(21) Appl. No.: 17/135,197

(22) Filed: Dec. 28, 2020

Related U.S. Application Data
(60) Provisional application No. 62/955,211, filed on Dec. 30, 2019.
(60) Provisional application No. 62/955,200, filed on Dec. 30, 2019.

(51) Int. Cl. G06Q 30/02; G06N 20/00

(52) U.S. Cl. CPC G06Q 30/0269; G06N 20/00; G06Q 30/0244; G06Q 30/0254

(57) ABSTRACT

A method for implementing an enterprise's outbound campaign in which an offer is communicated to target customers in a manner personalized for each. The method includes: providing a customer profile database; providing a personalization platform; updating the customer profile of a first target customer according to data received from a personal bot running on a device of the first target customer; deriving interaction predictors for the first target customer relating to behavioral tendency for a interaction type; receiving an enterprise campaign dataset from the enterprise related to the outbound campaign, the enterprise campaign dataset including: information describing the offer, context; and list of the target customers; augmenting, at the personalization platform, the enterprise campaign dataset with the interaction predictors related to the first target customer to produce an enriched campaign dataset; and transmitting the enriched campaign dataset to the enterprise.

### CROSS REFERENCE TO RELATED APPLICATION

This application claims the benefit of U.S. Provisional Patent Application No. 62/955,200, titled “PERSONALIZATION PLATFORM ASSISTING CUSTOMERS THROUGH PERSONAL BOTS”, filed in the U.S. Patent and Trademark Office on Dec. 30, 2019, the contents of which are incorporated herein. This application further claims the benefit of U.S. Provisional Patent Application No. 62/955,211, titled “PERSONALIZATION PLATFORM FOR OUTBOUND SERVERS OF ENTERPRISES”, filed in the U.S. Patent and Trademark Office on Dec. 30, 2019, the contents of which are incorporated herein.

### BACKGROUND

The present invention generally relates to telecommunications systems in the field of customer relations management including customer assistance via call or contact centers and internet-based service options. More particularly, but not by way of limitation, the present invention pertains to systems and methods for automating the aspects of contact center operations and customer experience, including customer services and outbound campaigns offered through functionality enabled via an application executed on a mobile computing device and a personalization platform.

### BRIEF DESCRIPTION OF THE INVENTION

The present invention includes a computer-implemented method related to implementing an outbound campaign of an enterprise in which an offer is communicated to target customers in a manner that is personalized for each of the target customers. When exemplified in relation to a first one of the target customers (hereinafter “first target customer”) in a manner representative of how the communication of the offer is personalized for each of the target customers, the method includes: providing a customer profile database, the customer profile database storing a customer profile of the first target customer and customer profiles of respective other customers; providing a personalization platform, the personalization platform includes an intermediary entity that is separate from both the first target customer and the enterprise, wherein the personalization platform includes access to the customer profiles stored in the customer profile database; updating the customer profile of the first target customer according to data received from a personal assistant bot application (hereafter “personal bot”) running on a personal communication device of the first target customer, wherein the personal bot is configured to update the customer profile of the first target customer by collecting interaction data describing interactions conducted by the first target customer via the personal communication device with other enterprises; deriving interaction predictors, each one of the interaction predictors including knowledge about the first target customer, the knowledge describing a behavioral tendency attributable to the first target customer for given a type of interaction, wherein the derivation of the interaction predictors is based on at least one of: a behavioral tendency exhibited by the first target customer given the interaction data stored in the customer profile of the first target customer; and a behavioral tendency exhibited by a group of the other customers given interaction data stored in the customer profiles that describes interactions that occurred between the other customers and the other enterprises, wherein the first target customer is found to have a characteristic common to the group of the other customers and wherein the characteristic is found to be correlate with the behavioral tendency; receiving, at the personalization platform, an enterprise campaign dataset from the enterprise related to the outbound campaign, the enterprise campaign dataset including at least: information describing the offer and a context of the outbound campaign; and a list of the target customers; augmenting, at the personalization platform, the enterprise campaign dataset with one or more of the interaction predictors related to the first target customer to produce an enriched campaign dataset by: selecting the one or more of the interaction predictors (hereafter “selected interaction predictors”) based on a relevance to the context of the outbound campaign; and including, in the enriched campaign dataset, the selected one or more interaction predictors as data linked to and describing the first target customer; and transmitting, from the personalization platform, the enriched campaign dataset to the enterprise for use thereby in implementing the outbound campaign.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 is schematic block diagram showing further details of a chat server operating as part of the chat system according to embodiments of the present invention;

FIG. 4 is a schematic block diagram of a chat module according to embodiments of the present invention;

FIG. 5 is an exemplary customer chat interface according to embodiments of the present invention;

FIG. 6 is a block diagram of a customer automation system according to embodiments of the present invention;

FIG. 7 is a flowchart of a method for automating an interaction on behalf of a customer according to embodiments of the present invention;

FIG. 8 is a block diagram of an automated personal bot for a customer according to embodiments of the present invention;

FIG. 9 is a schematic representation of an exemplary system including a personal bot and personalized customer profile in accordance with the present invention;

FIG. 10 is a process related to personalized customer profile in accordance with the present invention;

FIG. 11 is a schematic representation of an automated routing system in accordance with the present invention;

FIG. 12 is a routing process in accordance with the present invention;

FIG. 13 is a routing process in accordance with the present invention;

FIG. 14 is a schematic representation of a personalization platform in accordance with the present invention; and

FIG. 15 is a process related to the operation of the personalization platform of FIG. 14 in accordance with the present invention.

### DETAILED DESCRIPTION

For the purposes of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art.

As used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments”, “certain embodiments” and the like means that a particular feature, structure or characteristic described in connection with the given example may be included in at least one embodiment of the present invention. Thus, appearances of the phrases “an embodiment”, “one embodiment”, “present embodiments”, “exemplary embodiments”, “certain embodiments” and the like are not necessarily referring to the same embodiment or example. Further, particular features, structures or characteristics may be combined in any suitable combinations and/or sub-combinations in one or more embodiments or examples.

Those skilled in the art will recognize from the present disclosure that the various embodiments may be computer implemented using many different types of data processing equipment, with embodiments being implemented as an apparatus, method, or computer program product. Example embodiments, thus, may take the form of an entirely hardware embodiment, an entirely software embodiment, or an embodiment combining software and hardware aspects. Example embodiments further may take the form of a computer program product embodied by computer-usable program code in any tangible medium of expression. In each case, the example embodiment may be generally referred to as a “module”, “system”, or “method”.

The flowcharts and block diagrams provided in the figures illustrate architecture, functionality, and operation of possible implementations of systems, methods, and computer program products in accordance with example embodiments of the present invention. In this regard, it will be understood that each block of the flowcharts and/or block diagrams—or combinations of those blocks—may represent a module, segment, or portion of program code having one or more executable instructions for implementing the specified logical functions. It will similarly be understood that each of block of the flowcharts and/or block diagrams—or combinations of those blocks—may be implemented by special purpose hardware-based systems or combinations of special purpose hardware and computer instructions performing the specified acts or functions. Such computer program instructions also may be stored in a computer-readable medium that can direct a computer or other programmable data processing apparatus to function in a particular manner, such that the program instructions in the computer-readable medium produces an article of manufacture that includes instructions by which the functions or acts specified in each block of the flowcharts and/or block diagrams—or combinations of those blocks—are implemented.

### Computing Device

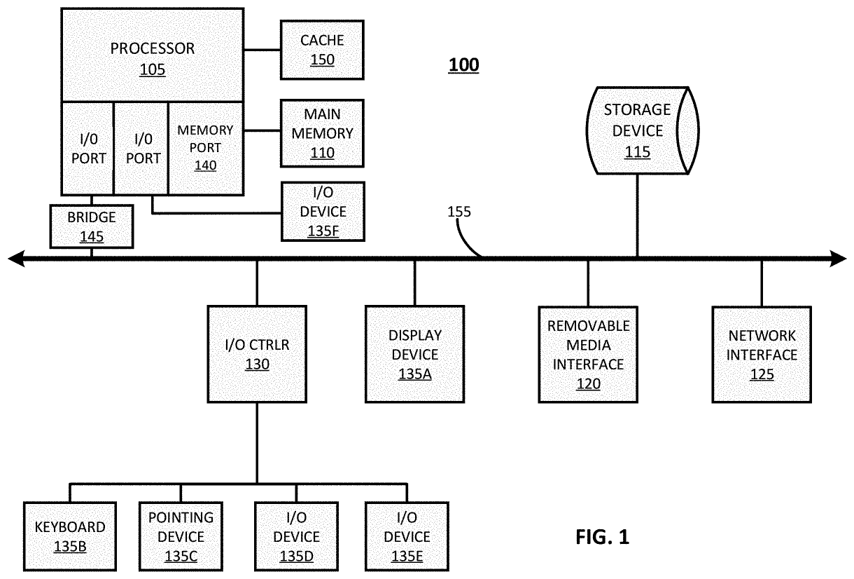

It will be appreciated that the systems and methods of the present invention may be computer implemented using many different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced. It should be understood that FIG. 1 is provided as a non-limiting example.

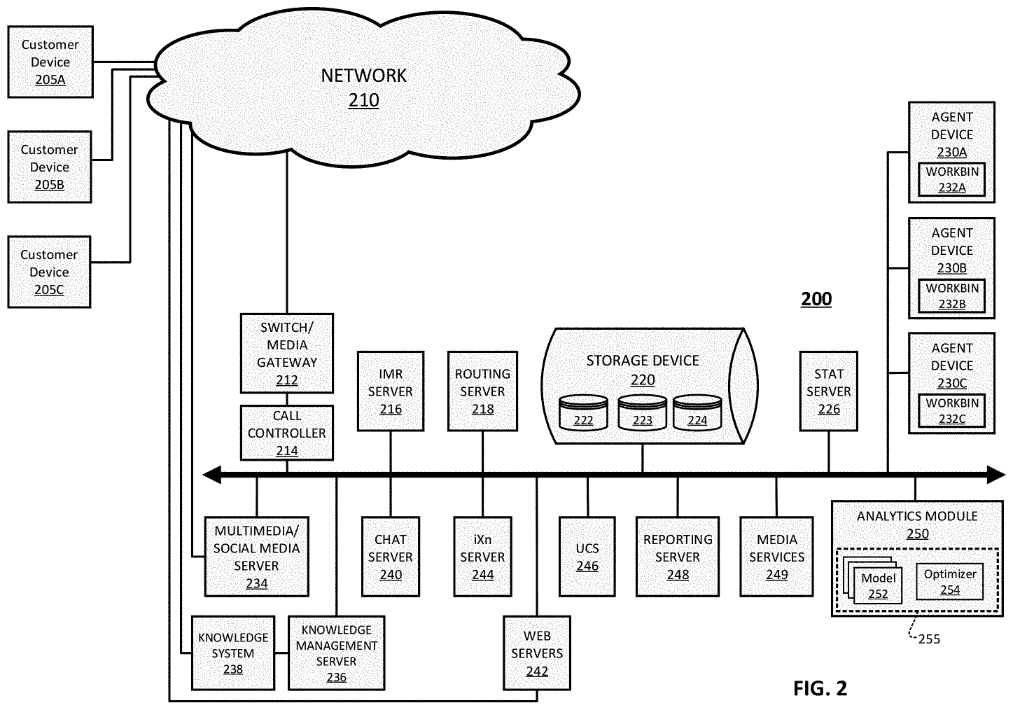

The computing device 100, for example, may be implemented via firmware (e.g., an application-specific integrated circuit), hardware, or a combination of software, firmware, and hardware. It will be appreciated that each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center system 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the process 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The cache memory 150 typically has a faster response time than main memory 110. The main memory 110 may be one or more memory chips capable of storing data and allowing stored data to be directly accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

The computing device 100 may be any workstation, desktop computer, laptop or notebook computer, server machine, virtualized machine, mobile or smart phone, portable telecommunication device, media playing device, gaming system, mobile computing device, or any other type of computing, telecommunications or media device, without limitation, capable of performing the operations and functionality described herein. The computing device 100 includes a plurality of devices connected by a network or connected to other systems and resources via a network. As used herein, a network includes one or more computing devices, machines, clients, client nodes, client machines, client computers, client devices, endpoints, or endpoint nodes in communication with one or more other computing devices, machines, clients, client nodes, client machines, client computers, client devices, endpoints, or endpoint nodes. For example, the network may be a private or public switched telephone network (PSTN), wireless carrier network, local area network (LAN), private wide area network (WAN), public WAN such as the Internet, etc., with connections being established using appropriate communication protocols. More generally, it should be understood that, unless otherwise limited, the computing device 100 may communicate with other computing devices 100 via any type of network using any conventional communication protocol. Further, the network may be a virtual network environment where various network components are virtualized. For example, the various machines may be virtual machines implemented as a software-based computer running on a physical machine, or a “hypervisor” type of virtualization may be used where multiple virtual machines run on the same host physical machine. Other types of virtualization are also contemplated.

### Contact Center

With reference now to FIG. 2, a communications infrastructure or contact center system 200 is shown in accordance with exemplary embodiments of the present invention and/or with which exemplary embodiments of the present invention may be enabled or practiced. It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and the like. In many cases this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

Referring specifically to FIG. 2, the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an inhouse facility to a business or enterprise for performing the functions of sales and customer service relative to products and services available through the enterprise. In another aspect, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely in a cloud environment, as indicated, or some combination thereof. It should further be appreciated that the various components of the contact center system 200 may be distributed across various geographic locations and not necessarily contained in a single location or computing environment.

It should further be understood that, unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center system 200 may include: a plurality of customer devices 205A, 205B, 205C; communications network (or simply “network”) 210; switch/media gateway 212; call controller 214; interactive media response (IMR) server 216; routing server 218; storage device 220; statistics (or “stat”) server 226; plurality of agent devices 230A, 230B, 230C that include workbins 232A, 232B, 232C, respectively; multimedia/social media server 234; knowledge management server 236 coupled to a knowledge system 238; chat server 240; web servers 242; interaction (or “iXn”) server 244; universal contact server (or “UCS”) 246; reporting server 248; media services server 249; and analytics module 250. It should be understood that any of the computer-implemented components, modules, or servers described in relation to FIG. 2 or in any of the following figures may be implemented via types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and the like.

Customers desiring to receive services from the contact center system 200 may initiate inbound communications (e.g., telephone calls, emails, chats, etc.) to the contact center system 200 via a customer device 205. While FIG. 2 shows three such customer devices—i.e., customer devices 205A, 205B, and 205C—it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access (CDMA) network, global system for mobile communications (GSM) network, or any wireless network/technology conventional in the art, including but not limited to 3G, 4G, LTE, 5G, etc.

In regard to the switch/media gateway 212, it may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VoIP calls, etc. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

In regard to the interactive media response (IMR) server 216, it may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may tell customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource.

In regard to the routing server 218, it may function to route incoming interactions. For example, once it is determined that an inbound communication should be handled by a human agent, functionality within the routing server 218 may select the most appropriate agent and route the communication thereto. This agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

Regarding data storage, the contact center system 200 may include one or more mass storage devices—represented generally by the storage device 220—for storing data in one or more databases relevant to the functioning of the contact center. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center system 200 may include agent availability and agent profiles, schedules, skills, handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therewithin or transmit data thereto for storage. The storage device 220, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

In regard to the stat server 226, it may be configured to record and aggregate data relating to the performance and operational aspects of the contact center system 200. Such information may be compiled by the stat server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center system 200 in ways that facilitate functionality described herein. An agent device 230, for example, may include a telephone adapted for regular telephone calls or VoIP calls. An agent device 230 may further include a computing device configured to communicate with the servers of the contact center system 200, perform data processing associated with operations, and interface with customers via voice, chat, email, and other multimedia communication mechanisms according to functionality described herein. While FIG. 2 shows three such agent devices—i.e., agent devices 230A, 230B and 230C—it should be understood that any number may be present.

In regard to the multimedia/social media server 234, it may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

In regard to the knowledge management server 234, it may be configured facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art. As an example, the knowledge system 238 may be embodied as IBM Watson or a like system.

In regard to the chat server 240, it may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 234 and the knowledge systems 238 for receiving suggestions and answers to queries posed by customers during a chat so that, for example, links to relevant articles can be provided.

In regard to the web servers 242, such servers may be included to provide site hosts for a variety of social interaction sites to which customers subscribe, such as Facebook, Twitter, Instagram, etc. Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

In regard to the interaction (iXn) server 244, it may be configured to manage deferrable activities of the contact center and the routing thereof to human agents for completion. As used herein, deferrable activities include back-office work that can be performed off-line, e.g., responding to emails, attending training, and other activities that do not entail real-time communication with a customer. As an example, the interaction (iXn) server 244 may be configured to interact with the routing server 218 for selecting an appropriate agent to handle each of the deferable activities. Once assigned to a particular agent, the deferable activity is pushed to that agent so that it appears on the agent device 230 of the selected agent. The deferable activity may appear in a workbin 232 as a task for the selected agent to complete. The functionality of the workbin 232 may be implemented via any conventional data structure, such as, for example, a linked list, array, etc. Each of the agent devices 230 may include a workbin 232, with the workbins 232A, 232B, and 232C being maintained in the agent devices 230A, 230B, and 230C, respectively. As an example, a workbin 232 may be maintained in the buffer memory of the corresponding agent device 230.

In regard to the universal contact server (UCS) 246, it may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

In regard to the reporting server 248, it may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to specific requests from a requestor (e.g., agent, administrator, contact center application, etc.). The reports then may be used toward managing the contact center operations in accordance with functionality described herein.

In regard to the media services server 249, it may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and the like.

In regard to the analytics module 250, it may be configured to provide systems and methods for performing analytics on data received from a plurality of different data sources as functionality described herein may require. In accordance with example embodiments, the analytics module 250 also may generate, update, train, and modify predictors or models 252 based on collected data, such as, for example, customer data, agent data, and interaction data. The models 252 may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module 250 is depicted as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database 222 and agent database 223. The analytics module 250 also may have access to the interaction database 224, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, as discussed more below, the analytic module 250 may be configured to retrieve data stored within the storage device 220 for use in developing and training algorithms and models 252, for example, by applying machine learning techniques.

One or more of the included models 252 may be configured to predict customer or agent behavior and/or aspects related to contact center operation and performance. Further, one or more of the models 252 may be used in natural language processing and, for example, include intent recognition and the like. The models 252 may be developed based upon 1) known first principle equations describing a system, 2) data, resulting in an empirical model, or 3) a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, it may be preferable that the models 252 are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach is presently a preferred embodiment for implementing the models 252. Neural networks, for example, may be developed based upon empirical data using advanced regression algorithms.

The analytics module 250 may further include an optimizer 254. As will be appreciated, an optimizer may be used to minimize a “cost function” subject to a set of constraints, where the cost function is a mathematical representation of desired objectives or system operation. Because the models 252 may be non-linear, the optimizer 254 may be a nonlinear programming optimizer. It is contemplated, however, that the present invention may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to exemplary embodiments, the models 252 and the optimizer 254 may together be used within an optimization system 255. For example, the analytics module 250 may utilize the optimization system 255 as part of an optimization process by which aspects of contact center performance and operation are optimized or, at least, enhanced. This, for example, may include aspects related to the customer experience, agent experience, interaction routing, natural language processing, intent recognition, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment.

### Chat Systems

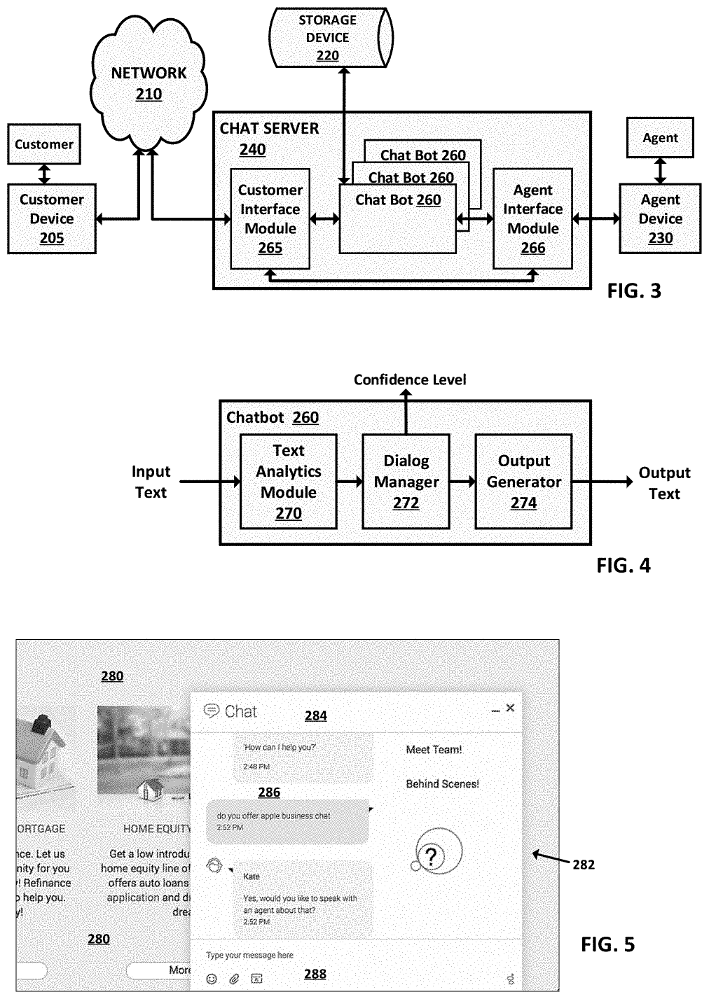

Turning to FIGS. 3, 4 and 5, various aspects of chat systems and chatbots are shown. As will be seen, present embodiments may include or be enabled by such chat features, which, in general, enable the exchange of text messages between different parties. Those parties may include live persons, such as customers and agents, as well as automated processes, such as bots or chatbots.

By way of background, a bot (also known as an “Internet bot”) is a software application that runs automated tasks or scripts over the Internet. Typically, bots perform tasks that are both simple and structurally repetitive at a much higher rate than would be possible for a person. A chatbot is a particular type of bot and, as used herein, is defined as a piece of software and/or hardware that conducts a conversation via auditory or textual methods. As will be appreciated, chatbots are often designed to convincingly simulate how a human would behave as a conversational partner. Chatbots are typically used in dialog systems for various practical purposes including customer service or information acquisition. Some chatbots use sophisticated natural language processing systems, while simpler ones scan for keywords within the input and then select a reply from a database based on matching keywords or wording pattern.

Before proceeding further with the description of the present invention, an explanatory note will be provided in regard to referencing system components—e.g., modules, servers, and other components—that have already been introduced in any previous figure. Whether or not the subsequent reference includes the corresponding numerical identifiers used in the previous figures, it should be understood that the reference incorporates the example described in the previous figures and, unless otherwise specifically limited, may be implemented in accordance with either that examples or other conventional technology capable of fulfilling the desired functionality, as would be understood by one of ordinary skill in the art. Thus, for example, subsequent mention of a “contact center system” should be understood as referring to the exemplary “contact center system 200” of FIG. 2 and/or other conventional technologies for implementing a contact center system. As additional examples, a subsequent mention below to a “customer device”, “agent device”, “chat server”, or “computing device” should be understood as referring to the exemplary “customer device 205”, “agent device 230”, “chat server 240”, or “computing device 200”, respectively, of FIGS. 1-2, as well as conventional technology for fulfilling the same functionality.

Chat features and chatbots will now be discussed in greater specificity with reference to the exemplary embodiments of a chat server, chatbot, and chat interface depicted, respectively, in FIGS. 3, 4, and 5. While these examples are provided with respect to chat systems implemented on the contact center-side, such chat systems may be used on the customer-side of an interaction. Thus, it should be understood that the exemplary chat systems of FIGS. 3, 4, and 5 may be modified for analogous customer-side implementation, including the use of customer-side chatbots configured to interact with agents and chatbots of contact centers on a customer's behalf. It should further be understood that chat features may be utilized by voice communications via converting text-to-speech and/or speech-to-text.

Referring specifically now to FIG. 3, a more detailed block diagram is provided of a chat server 240, which may be used to implement chat systems and features. The chat server 240 may be coupled to (i.e., in electronic communication with) a customer device 205 operated by the customer over a data communications network 210. The chat server 240, for example, may be operated by a enterprise as part of a contact center for implementing and orchestrating chat conversations with the customers, including both automated chats and chats with human agents. In regard to automated chats, the chat server 240 may host chat automation modules or chatbots 260A-260C (collectively referenced as 260), which are configured with computer program instructions for engaging in chat conversations. Thus, generally, the chat server 240 implements chat functionality, including the exchange of text-based or chat communications between a customer device 205 and an agent device 230 or a chatbot 260. As discussed more below, the chat server 240 may include a customer interface module 265 and agent interface module 266 for generating particular UIs at the customer device 205 and the agent device 230, respectively, that facilitate chat functionality.

In regard to the chatbots 260, each can operate as an executable program that is launched according to demand. For example, the chat server 240 may operate as an execution engine for the chatbots 260, analogous to loading VoiceXML files to a media server for interactive voice response (IVR) functionality. Loading and unloading may be controlled by the chat server 240, analogous to how a VoiceXML script may be controlled in the context of an interactive voice response. The chat server 240 may further provide a means for capturing and collecting customer data in a unified way, similar to customer data capturing in the context of IVR. Such data can be stored, shared, and utilized in a subsequent conversation, whether with the same chatbot, a different chatbot, an agent chat, or even a different media type. In example embodiments, the chat server 240 is configured to orchestrate the sharing of data among the various chatbots 260 as interactions are transferred or transitioned over from one chatbot to another or from one chatbot to a human agent. The data captured during interaction with a particular chatbot may be transferred along with a request to invoke a second chatbot or human agent.

In exemplary embodiments, the number of chatbots 260 may vary according to the design and function of the chat server 240 and is not limited to the number illustrated in FIG. 3. Further, different chatbots may be created to have different profiles, which can then be selected between to match the subject matter of a particular chat or a particular customer. For example, the profile of a particular chatbot may include expertise for helping a customer on a particular subject or communication style aimed at a certain customer preference. More specifically, one chatbot may be designed to engage in a first topic of communication (e.g., opening a new account with the business), while another chatbot may be designed to engage in a second topic of communication (e.g., technical support for a product or service provided by the business). Or, chatbots may be configured to utilize different dialects or slang or have different personality traits or characteristics. Engaging chatbots with profiles that are catered to specific types of customers may enable more effective communication and results. The chatbot profiles may be selected based on information known about the other party, such as demographic information, interaction history, or data available on social media. The chat server 240 may host a default chatbot that is invoked if there is insufficient information about the customer to invoke a more specialized chatbot. Optionally, the different chatbots may be customer selectable. In exemplary embodiments, profiles of chatbots 260 may be stored in a profile database hosted in the storage device 220. Such profiles may include the chatbot's personality, demographics, areas of expertise, and the like.

The customer interface module 265 and agent interface module 266 may be configured to generating user interfaces (UIs) for display on the customer device 205 that facilitate chat communications between the customer and a chatbot 260 or human agent. Likewise, an agent interface module 266 may generate particular UIs on the agent device 230 that facilitate chat communications between an agent operating an agent device 230 and the customer. The agent interface module 266 may also generate UIs on an agent device 230 that allow an agent to monitor aspects of an ongoing chat between a chatbot 260 and a customer. For example, the customer interface module 265 may transmit signals to the customer device 205 during a chat session that are configured to generated particular UIs on the customer device 205, which may include the display of the text messages being sent from the chatbot 260 or human agent as well as other non-text graphics that are intended to accompany the text messages, such as emoticons or animations. Similarly, the agent interface module 266 may transmit signals to the agent device 230 during a chat session that are configured to generated UIs on the agent device 230. Such UIs may include an interface that facilitates the agent selection of non-text graphics for accompanying outgoing text messages to customers.

In exemplary embodiments, the chat server 240 may be implemented in a layered architecture, with a media layer, a media control layer, and the chatbots executed by way of the IMR server 216 (similar to executing a VoiceXML on an IVR media server). As described above, the chat server 240 may be configured to interact with the knowledge management server 234 to query the server for knowledge information. The query, for example, may be based on a question received from the customer during a chat. Responses received from the knowledge management server 234 may then be provided to the customer as part of a chat response.

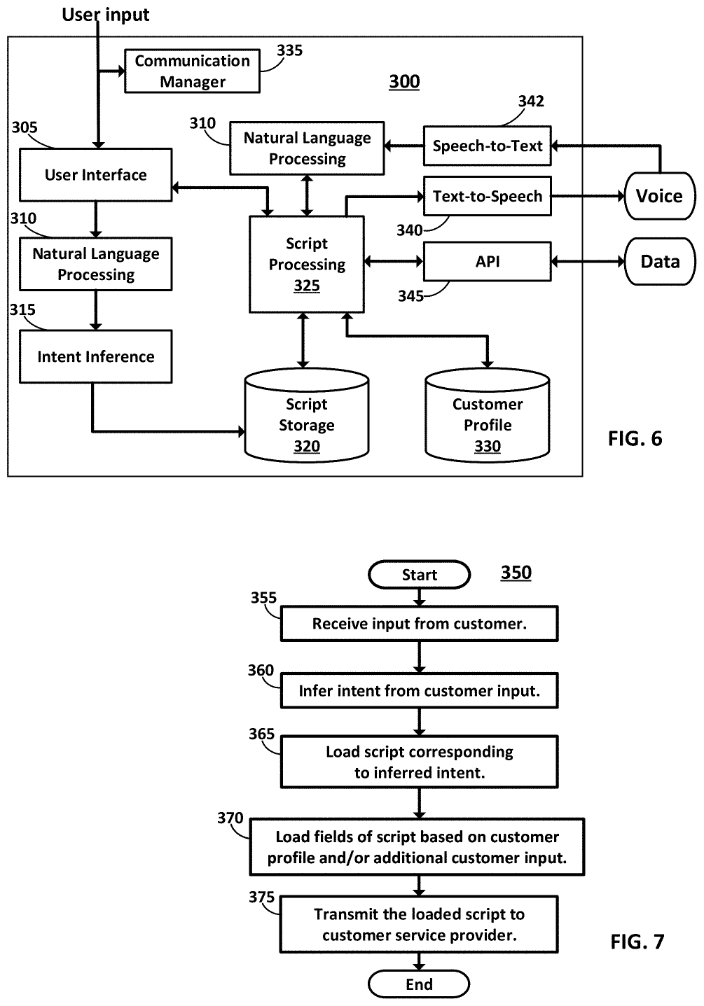

Referring specifically now to FIG. 4, a block diagram is provided of an exemplary chat automation module or chatbot 260. As illustrated, the chatbot 260 may include several modules, including a text analytics module 270, dialog manager 272, and output generator 274. It will be appreciated that, in a more detailed discussion of chatbot operability, other subsystems or modules may be described, including, for examples, modules related to intent recognition, text-to-speech or speech-to-text modules, as well as modules related to script storage, retrieval, and data field processing in accordance with information stored in agent or customer profiles. Such topics, however, are covered more completely in other areas of this disclosure—for example, in relation to FIGS. 6 and 7—and so will not be repeated here. It should nevertheless be understood that the disclosures made in these areas may be used in analogous ways toward chatbot operability in accordance with functionality described herein.

The text analytics module 270 may be configured to analyze and understand natural language. In this regard, the text analytics module may be configured with a lexicon of the language, syntactic/semantic parser, and grammar rules for breaking a phrase provided by the customer device 205 into an internal syntactic and semantic representation. The configuration of the text analytics module depends on the particular profile associated with the chatbot. For example, certain words may be included in the lexicon for one chatbot but excluded that of another.

The dialog manager 272 receives the syntactic and semantic representation from the text analytics module 270 and manages the general flow of the conversation based on a set of decision rules. In this regard, the dialog manager 272 maintains a history and state of the conversation and, based on those, generates an outbound communication. The communication may follow the script of a particular conversation path selected by the dialog manager 272. As described in further detail below, the conversation path may be selected based on an understanding of a particular purpose or topic of the conversation. The script for the conversation path may be generated using any of various languages and frameworks conventional in the art, such as, for example, artificial intelligence markup language (AIML), SCXML, or the like.

During the chat conversation, the dialog manager 272 selects a response deemed to be appropriate at the particular point of the conversation flow/script and outputs the response to the output generator 274. In exemplary embodiments, the dialog manager 272 may also be configured to compute a confidence level for the selected response and provide the confidence level to the agent device 230. Every segment, step, or input in a chat communication may have a corresponding list of possible responses. Responses may be categorized based on topics (determined using a suitable text analytics and topic detection scheme) and suggested next actions are assigned. Actions may include, for example, responses with answers, additional questions, transfer to a human agent to assist, and the like. The confidence level may be utilized to assist the system with deciding whether the detection, analysis, and response to the customer input is appropriate or whether a human agent should be involved. For example, a threshold confidence level may be assigned to invoke human agent intervention based on one or more business rules. In exemplary embodiments, confidence level may be determined based on customer feedback. As described, the response selected by the dialog manager 272 may include information provided by the knowledge management server 234.

In exemplary embodiments, the output generator 274 takes the semantic representation of the response provided by the dialog manager 272, maps the response to a chatbot profile or personality (e.g., by adjusting the language of the response according to the dialect, vocabulary, or personality of the chatbot), and outputs an output text to be displayed at the customer device 205. The output text may be intentionally presented such that the customer interacting with a chatbot is unaware that it is interacting with an automated process as opposed to a human agent. As will be seen, in accordance with other embodiments, the output text may be linked with visual representations, such as emoticons or animations, integrated into the customer's user interface.

Reference will now be made to FIG. 5, in which a webpage 280 having an exemplary implementation of a chat feature 282 is presented. The webpage 280, for example, may be associated with a enterprise website and intended to initiate interaction between prospective or current customers visiting the webpage and a contact center associated with the enterprise. As will be appreciated, the chat feature 282 may be generated on any type of customer device 205, including personal computing devices such as laptops, tablet devices, or smart phones. Further, the chat feature 282 may be generated as a window within a webpage or implemented as a full-screen interface. As in the example shown, the chat feature 282 may be contained within a defined portion of the webpage 280 and, for example, may be implemented as a widget via the systems and components described above and/or any other conventional means. In general, the chat feature 282 may include an exemplary way for customers to enter text messages for delivery to a contact center.

As an example, the webpage 280 may be accessed by a customer via a customer device, such as the customer device, which provides a communication channel for chatting with chatbots or live agents. In exemplary embodiments, as shown, the chat feature 282 includes generating a user interface, which is referred to herein as a customer chat interface 284, on a display of the customer device. The customer chat interface 284, for example, may be generated by the customer interface module of a chat server, such as the chat server, as already described. As described, the customer interface module 265 may send signals to the customer device 205 that are configured to generate the desired customer chat interface 284, for example, in accordance with the content of a chat message issued by a chat source, which, in the example, is a chatbot or agent named “Kate”. The customer chat interface 284 may be contained within a designated area or window, with that window covering a designated portion of the webpage 280. The customer chat interface 284 also may include a text display area 286, which is the area dedicated to the chronological display of received and sent text messages. The customer chat interface 284 further includes a text input area 288, which is the designated area in which the customer inputs the text of their next message. As will be appreciated, other configurations are also possible.

### Customer Automation Systems

Embodiments of the present invention include systems and methods for automating and augmenting customer actions during various stages of interaction with a customer service provider or contact center. As will be seen, those various stages of interaction may be classified as pre-contact, during-contact, and post-contact stages (or, respectively, pre-interaction, during-interaction, and post-interaction stages). With specific reference now to FIG. 6, an exemplary customer automation system 300 is shown that may be used with embodiments of the present invention. To better explain how the customer automation system 300 functions, reference will also be made to FIG. 7, which provides a flowchart 350 of an exemplary method for automating customer actions when, for example, the customer interacts with a contact center. Additional information related to customer automation is provided in U.S. application Ser. No. 16/151,362, filed on Oct. 4, 2018, entitled “System and Method for Customer Experience Automation”, the content of which is incorporated herein by reference.

The customer automation system 300 of FIG. 6 represents a system that may be generally used for customer-side automations, which, as used herein, refers to the automation of actions taken on behalf of a customer in interactions with customer service providers or contact centers. Such interactions may also be referred to as “customer-contact center interactions” or simply “customer interactions”. Further, in discussing such customer-contact center interactions, it should be appreciated that reference to a “contact center” or “customer service provider” is intended to generally refer to any customer service department or other service provider associated with an organization or enterprise (such as, for example, a business, governmental agency, non-profit, school, etc.) with which a user or customer has business, transactions, affairs or other interests.

In exemplary embodiments, the customer automation system 300 may be implemented as a software program or application running on a mobile device or other computing device, cloud computing devices (e.g., computer servers connected to the customer device 205 over a network), or combinations thereof (e.g., some modules of the system are implemented in the local application while other modules are implemented in the cloud. For the sake of convenience, embodiments are primarily described in the context of implementation via an application running on the customer device 205. However, it should be understood that present embodiments are not limited thereto.

The customer automation system 300 may include several components or modules. In the illustrated example of FIG. 6, the customer automation system 300 includes a user interface 305, natural language processing (NLP) module 310, intent inference module 315, script storage module 320, script processing module 325, customer profile database or module (or simply “customer profile”) 330, communication manager module 335, text-to-speech module 340, speech-to-text module 342, and application programming interface (API) 345, each of which will be described with more particularity with reference also to flowchart 350 of FIG. 7. It will be appreciated that some of the components of and functionalities associated with the customer automations system 300 may overlap with the chatbot systems described above in relation to FIGS. 3, 4, and 5. In cases where the customer automation system 300 and such chatbot systems are employed together as part of a customer-side implementation, such overlap may include the sharing of resources between the two systems.

In an example of operation, with specific reference now to the flowchart 350 of FIG. 7, the customer automation system 300 may receive input at an initial step or operation 355. Such input may come from several sources. For example, a primary source of input may be the customer, where such input is received via the customer device. The input also may include data received from other parties, particularly parties interacting with the customer through the customer device. For example, information or communications sent to the customer from the contact center may provide aspects of the input. In either case, the input may be provided in the form of free speech or text (e.g., unstructured, natural language input). Input also may include other forms of data received or stored on the customer device.

Continuing with the flow diagram 350, at an operation 360, the customer automation system 300 parses the natural language of the input using the NLP module 310 and, therefrom, infers an intent using the intent inference module 315. For example, where the input is provided as speech from the customer, the speech may be transcribed into text by a speech-to-text system (such as a large vocabulary continuous speech recognition or LVCSR system) as part of the parsing by the NLP module 310. The transcription may be performed locally on the customer device 205 or the speech may be transmitted over a network for conversion to text by a cloud-based server. In certain embodiments, for example, the intent inference module 315 may automatically infer the customer's intent from the text of the provided input using artificial intelligence or machine learning techniques. Such artificial intelligence techniques may include, for example, identifying one or more keywords from the customer input and searching a database of potential intents corresponding to the given keywords. The database of potential intents and the keywords corresponding to the intents may be automatically mined from a collection of historical interaction recordings. In cases where the customer automation system 300 fails to understand the intent from the input, a selection of several intents may be provided to the customer in the user interface 305. The customer may then clarify their intent by selecting one of the alternatives or may request that other alternatives be provided.

After the customer's intent is determined, the flowchart 350 proceeds to an operation 365 where the customer automation system 300 loads a script associated with the given intent. Such scripts, for example, may be stored and retrieved from the script storage module 320. Such scripts may include a set of commands or operations, pre-written speech or text, and/or fields of parameters or data (also “data fields”), which represent data that is required to automate an action for the customer. For example, the script may include commands, text, and data fields that will be needed in order to resolve the issue specified by the customer's intent. Scripts may be specific to a particular contact center and tailored to resolve particular issues. Scripts may be organized in a number of ways, for example, in a hierarchical fashion, such as where all scripts pertaining to a particular organization are derived from a common “parent” script that defines common features. The scripts may be produced via mining data, actions, and dialogue from previous customer interactions. Specifically, the sequences of statements made during a request for resolution of a particular issue may be automatically mined from a collection of historical interactions between customers and customer service providers. Systems and methods may be employed for automatically mining effective sequences of statements and comments, as described from the contact center agent side, are described in U.S. patent application Ser. No. 14/153,049 “Computing Suggested Actions in Caller Agent Phone Calls By Using Real-Time Speech Analytics and Real-Time Desktop Analytics,” filed in the United States Patent and Trademark Office on Jan. 12, 2014, the entire disclosure of which is incorporated by reference herein.

With the script retrieved, the flowchart 350 proceeds to an operation 370 where the customer automation system 300 processes or “loads” the script. This action may be performed by the script processing module 325, which performs it by filling in the data fields of the script with appropriate data pertaining to the customer. More specifically, the script processing module 325 may extract customer data that is relevant to the anticipated interaction, with that relevance being predetermined by the script selected as corresponding to the customer's intent. The data for many of the data fields within the script may be automatically loaded with data retrieved from data stored within the customer profile 330. As will be appreciated, the customer profile 330 may store particular data related to the customer, for example, the customer's name, birth date, address, account numbers, authentication information, and other types of information relevant to customer service interactions. The data selected for storage within the customer profile 330 may be based on data the customer has used in previous interactions and/or include data values obtained directly by the customer. In case of any ambiguity regarding the data fields or missing information within a script, the script processing module 325 may include functionality that prompts and allows the customer to manually input the needed information.

Referring again to the flowchart 350, at an operation 375, the loaded script may be transmitted to the customer service provider or contact center. As discussed more below, the loaded script may include commands and customer data necessary to automate at least a part of an interaction with the contact center on the customer's behalf. In exemplary embodiments, an API 345 is used so to interact with the contact center directly. Contact centers may define a protocol for making commonplace requests to their systems, which the API 345 is configured to do. Such APIs may be implemented over a variety of standard protocols such as Simple Object Access Protocol (SOAP) using Extensible Markup Language (XML), a Representational State Transfer (REST) API with messages formatted using XML or JavaScript Object Notation (JSON), and the like. Accordingly, the customer automation system 300 may automatically generate a formatted message in accordance with a defined protocol for communication with a contact center, where the message contains the information specified by the script in appropriate portions of the formatted message.

### Personal Bot

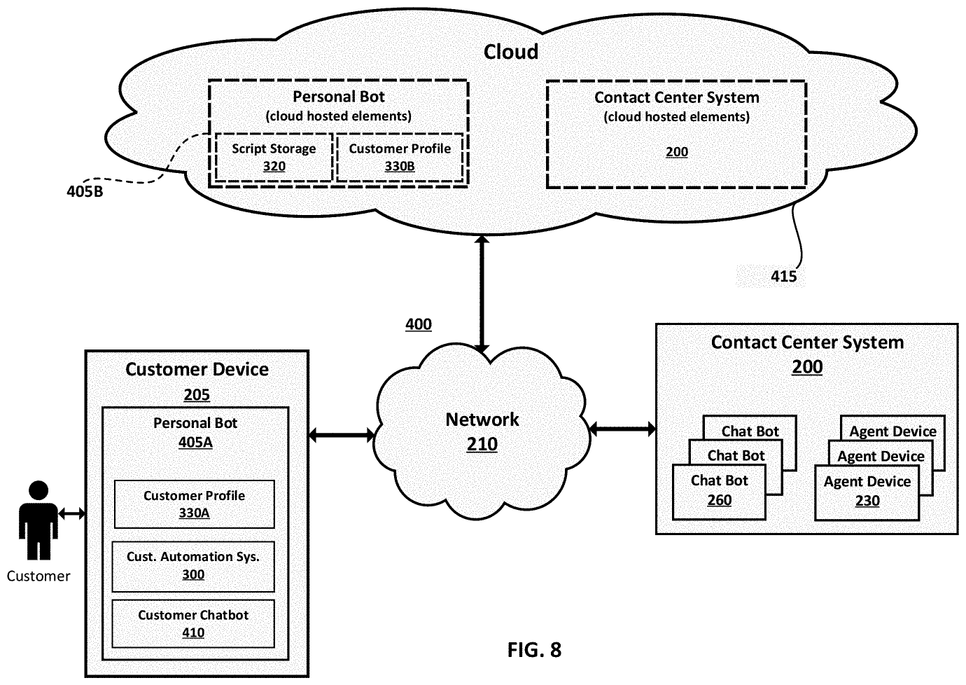

With reference now to FIG. 8, an exemplary system 400 is shown that includes an automated personal assistant or, as referred to herein, personal bot 405. As will be seen, the personal bot 405 is configured to automate aspects of interactions with a customer service provider on behalf of a customer. As stated above, present invention relates to systems and methods for automating aspects of the customer-side of the interactions between customers and customer service providers or contact centers. Accordingly, the personal bot 405 may provide ways to automate actions that customers are required to perform when contacting, interacting, or following up with contact centers.

The personal bot 405, as used herein, may generally reference any customer-side implementation of any of the automated processes or automation functionality described herein. Thus, it should be understood that, unless otherwise specifically limited, the personal bot 405 may generally employ any of the technologies discussed herein—including those related to the chatbots 260 and the customer automation system 300—to enable or enhance automation services available to customers. For example, as indicated in FIG. 8, the personal bot 405 may include the functionality of the above-described customer automation system 300. Additionally, the personal bot 405 may include a customer-side implementation of a chatbot (for example, the chatbot 260 of FIGS. 4 and 5), which will be referred herein as a customer chatbot 410. As will be seen, the customer chatbot 410 may be configured to interact privately with the customer in order to obtain feedback and direction from the customer pertaining to actions related to ongoing, future, or past interactions with contact centers. Further, the customer chatbot 410 may be configured to interact with live agents or chatbots associated with a contact center on behalf of the customer.

As shown in FIG. 8, in regard to system architecture, the personal bot 405 may be implemented as a software program or application running on a mobile device or personal computing device (shown as a customer device 205) of the customer. For example, the personal bot 405A may include locally stored modules, including the customer automation system 300, the customer chatbot 410, and elements of the customer profile 330A. The personal bot 405 also may include remote or cloud computing components (e.g., one or more computer servers or modules connected to the customer device 205 over a network 210), which may be hosted in a cloud computing environment or cloud 415 (see cloud hosted elements of the personal bot 405B). For example, as shown in the illustrated example, the script storage module 320 and elements of the customer profile 330B may be stored in databases in the cloud 415. It should be understood, however, that present embodiments are not limited to this arrangement and, for example, may include other components being implemented in the cloud 415.

Accordingly, as will be seen, embodiments of the present invention include systems and methods for automatically initiating and conducting an interaction with a contact center to resolve an issue on behalf of a customer. Toward this objective, the personal bot 405 may be configured to automate particular aspects of interactions with a contact center on behalf of the customer. Several examples of these types of embodiments will now be discussed in which resources described herein—including the customer automation system 300 and customer chatbot 410—are used to provide the necessary automation. In presenting these embodiments, reference is also made to the disclosures, particularly those regarding customer automation and intent recognition, provided in U.S. application Ser. No. 16/730,698, filed on Dec. 30, 2019, entitled “System and Method Relating to Customer Experience Automation”, the content of which is incorporated herein by reference.

### Pre-Interaction Automation

Embodiments of the present invention include the personal bot 405 and related resources automating one or more actions or processes by which the customer initiates a communication with a contact center for interacting therewith. As will be seen, this type of automation is primarily aimed at those actions normally occurring within the pre-contact or pre-interaction stage of customer interactions.

For example, in accordance with an exemplary embodiment, when a customer chooses to contact a contact center, the customer automation system 300 may automate the process of connecting the customer with the contact center. For example, present embodiments may automatically navigate an IVR system of a contact center on behalf of the customer using a loaded script. Further, the customer automation system 300 may automatically navigate an IVR menu system for a customer, including, for example, authenticating the customer by providing authentication information (e.g., entering a customer number through dual-tone multi-frequency or DTMF or “touch tone” signaling or through text to speech synthesis) and selecting menu options (e.g., using DTMF signaling or through text to speech synthesis) to reach the proper department associated with the inferred intent from the customer's input. More specifically, the customer profile 330 may include authentication information that would typically be requested of customers accessing customer support systems such as usernames, account identifying information, personal identification information (e.g., a social security number), and/or answers to security questions. As additional examples, the customer automation system 300 may have access to text messages and/or email messages sent to the customer's account on the customer device 205 in order to access one-time passwords sent to the customer, and/or may have access to a one-time password (OTP) generator stored locally on the customer device 205. Accordingly, embodiments of the present invention may be capable of automatically authenticating the customer with the contact center prior to an interaction.

In addition, the customer automation system 300 may facilitate a customer contacting a contact center via multiple channels for communication, such as, call (e.g., voice and/or video), chat, or e-mail. In exemplary embodiments, the communication channels may include calling, chatting, and leaving a message. Estimated wait times for interactions with a live agent (e.g., call or chat) may also be shown to the customer. For example, if the customer chooses to call and speak with a live agent, the customer may be offered several options. These options might include to wait (e.g., “dial now and wait”), select a callback (e.g., “dial now and skip waiting”), or schedule a call for a given time (e.g., “schedule a callback”). In exemplary embodiments, if the customer selects to schedule a call for a given time by opting for “schedule a callback,” for example, the customer automation system 300 may access the customer's calendar (stored/accessible on the same customer device 205) and offer suggestions for free times in the customer's calendar. The customer automation system 300 may determine that the customer is free at particular times over the next two days. These times may be automatically presented to the customer for selection thereby. The customer may also choose to schedule the call at another time and input this into the user interface 305. Certain embodiments of the present invention may enable callback scheduling even when contact centers do not directly support such a feature. For example, assuming that the customer has scheduled a callback for 10:00 am, the system may automatically determine the approximate wait time during the time periods leading up to 10:00 am. This might be based on historical data captured from other customers contacting this particular organization or it may be based on wait time data published by the contact center. Thus, in accordance with exemplary embodiments, the customer automation system 300 automatically connects to the contact center at a time prior to the scheduled call back time, based on the expected wait time, and supplies the set of information provided to the customer automation system 300 in accordance with the script in order to be placed on hold by the contact center. For example, the customer automation system 300 may automatically determine that the expected wait time at 09:15 is 45 minutes, and therefore initiates communication with the contact center at 09:15 in order have an agent available to speak to the customer at around 10:00. When the customer automation system 300 is connected to a live contact center agent (e.g., by detecting a ringing on the contact center end of the communication channel or by detecting a voice saying “hello”), an automatic notification may be sent to the customer (e.g., by ringing at the customer device 205) and then the customer may be connected to the live agent.

In accordance with other embodiments, the customer automation system 300 may automate a process for preparing an agent before a call from a customer. For example, the customer automation system 300 may send a request that the agent study certain materials provided by the customer before the live call happens.

### During-Interaction Automation

Embodiments of the present invention further include the personal bot 405 and related resources automating the actual interaction (or aspects thereof) between the customer and a contact center. As will be seen, this type of automation is primarily aimed at those actions normally occurring within the during-contact or during-interaction stage of customer interactions.

For example, the customer automation system 300 may interact with entities within a contact center on behalf of the customer. Without limitation, such entities may include automated processes, such as chatbots, and live agents. Once connected to the contact center, the customer automation system 300 may retrieve a script from the script storage module 320 that includes an interaction script (e.g., a dialogue tree). The interaction script may generally consist of a template of statements for the customer automation system 300 to make to an entity within the contact center, for example, a live agent. In exemplary embodiments, the customer chatbot 410 may interact with the live agent on the customer's behalf in accordance with the interaction script. As already described, the interaction script (or simply “script”) may consist of a template having defined dialogue (i.e., predetermined text or statements) and data fields. As previously described, to “load” the script, information or data pertinent to the customer is determined and loaded into the appropriate data fields. Such pertinent data may be retrieved from the customer profile 330 and/or derived from input provided by the customer through the customer interface 305. According to certain embodiments, the customer chatbot 410 also may be used to interact with the customer to prompt such input so that all of the necessary data fields within the script are filled. In other embodiments, the script processing module 325 may prompt the customer to supply any missing information (e.g., information that is not available from the customer profile 330) to fill in blanks in the template through the user interface 305 prior to initiating a communication with the contact center. In certain embodiments, the script processing module 325 may also request that the customer confirm the accuracy of all of the information that the customer automation system 300 will provide to the contact center.

Once the loaded script is complete, for example, the interaction with the live agent may begin with an initial statement explaining the reason for the call (e.g., “I am calling on behalf of your customer, Mr. Thomas Anderson, regarding what appears to be double billing.”), descriptions of particular details related to the issue (e.g., “In the previous three months, his bill was approximately fifty dollars. However, his most recent bill was for one hundred dollars.”), and the like. While such statements may be provided in text to the contact center, it may also be provided in voice, for example, when interacting with a live agent. In regard to how such an embodiment may function, a speech synthesizer or text-to-speech module 340 may be used to generate speech to be transmitted to the contact center agent over a voice communication channel. Further, speech received from the agent of the contact center may be converted to text by a speech-to-text converter 342, and the resulting text then may be processed by the customer automation system 300 or customer chatbot 410 so that an appropriate response in the dialogue tree may be found. If the agent's response cannot be processed by the dialogue tree, the customer automation system 300 may ask the agent to rephrase the response or may connect the customer to the agent in order to complete the transaction.

While the customer automation system 300 is conducting the interaction with the live agent in accordance with the interaction script, the agent may indicate their readiness or desire to speak to the customer. For the agent, readiness might occur after reviewing all of the media documents provided to the agent by the customer automation system 300 and/or after reviewing the customer's records. In exemplary embodiments, the script processing module 325 may detect a phrase spoken by the agent to trigger the connection of the customer to the agent via the communication channel (e.g., by ringing the customer device 205 of the customer). Such triggering phrases may be converted to text by the speech-to-text converter 342 and the natural language processing module 310 then may determine the meaning of the converted text (e.g., identifying keywords and/or matching the phrase to a particular cluster of phrases corresponding to a particular concept).

As another example, the customer automation system 300 may present automatically generated “quick actions” to the customer based on the customer's inferred intent and other data associated with the ongoing interaction. In some circumstances, the “quick actions” require no further input from the customer. For example, the customer automation system 300 may suggest sending an automatically generated text or email message to the contact center directly from a main menu screen, where the message describes the customer's issue. The message may be generated automatically by the script processing module based on a message template provided by the script, where portions of the template that contain customer-specific and incident-specific data are automatically filled in based on data collected about the customer (e.g., from the customer profile) and that the customer has supplied (e.g., as part of the initial customer input). For example, in the case where the customer input references a question about a possible double billing by a particular service provider, the script processing module 325 can reference previous billing statements, which may be stored as part of the customer profile 330, to look for historical charges. The customer automation system 300 infers from these previous billing statements that the amount charged for the period in question was unusually high. In such cases, the system may automatically generate a message which may contain the information about the customer's typical bills and the problem with the current bill. The customer can direct the customer automation system 300 to send the automatically generated message directly to the contact center associated with the service provider. In exemplary embodiments, the script may provide multiple templates, and the customer may select from among the templates and/or edit a message prior to sending, in order to match the customer's personality or preferred tone of voice.

In other exemplary embodiments, the personal bot 405 may automate processes that augment a current or ongoing interaction between the customer and a contact center (e.g., between the customer and either a chatbot or a live agent of the contact center). While the personal bot 405 may not handle the interaction in such embodiments, the personal bot may work behind the scenes to facilitate the customer's interaction with a contact center, so to increase the likelihood of a desirable outcome for the customer. In such embodiments, once the interaction has been initiated with a live agent, meta-data regarding the interaction may be displayed to the customer in the user interface 305. This may be done throughout the interaction, with the information being update based on the progression of the ongoing interaction. Examples of such information might include, but not be limited to, name of the contact center, name of the department reached, reason for the call, name of the contact center agent, name of other agents who were on the call, etc. According to exemplary embodiments, this type of information may include a transcript of the ongoing call so that the customer can easily look back at previous statements. In addition, the customer automation system 300 may display other types of information to the customer that is found pertinent given, for example, the recognition of certain key words within the transcript of the ongoing conversation. That is, the customer automation system 300 may push relevant content from a knowledge base (e.g., the knowledge system 238 of FIG. 2) to the customer given the content of the transcript of the interaction.

The customer automation system 300 also may enable the customer and agent to share relevant content with each other throughout the interaction. For example, in one embodiment, the agent or customer may share screens, documents (contracts, warranties, etc.), photos, and other files with each other. Other files may also be shared, such as screenshots of content captured by one of the parties during the conversation, a current view from a camera, links, photographs of broken or failed products, screenshots of error messages, copies of documents, proofs of purchase, or any other supporting file. The customer automation system 300, thus, may provide functionality that facilitates the customer supplying or sharing additional or augmenting material to an agent of the contact center that is relevant to an ongoing interaction. To do this, for example, a supplemental communication channels (e.g., a data channel) is established in parallel to the primary communication channel (e.g., a voice communication channel or a text communication channel) to transfer the augmenting information between the customer and the contact center agent. In certain embodiments, these documents may be provided along with an automatically generated “quick actions” message. For example, such quick action messages may prompt the customer to take a photo of the broken part, for inclusion in the shared material.

In accordance with other embodiments, the communication manager 335 monitors conditions for a customer based on specified intents and automatically generates notifications to be presented to the customer through the user interface 305. For example, based the previous activity of the customer (for example, the customer's billing statements, which may be stored in the customer profile 330, and communications from different contact centers), the communication manager 335 may automatically generate notifications which might be of interest to the customer. Examples of a notification generated by the communication manager may include a reminder about the upcoming expiration of a deal, an offer of a new deal, actions for the customer, and the like. For example, the notification may offer quick actions that can be performed directly from the notification screen, such as how to get a specific deal, call a contact center about a specific deal, search for more deals, cancel a service, etc. The communication manager 335 may customize notifications to the customer based on the customer's previous deals, billing statements, crowd-sourced information about how similar customers reacted to deals, personal preferences, and the like. The communication manager 335 may provide such functionality through the user interface 305 for the customer to search for more deals based on their needs. Should the customer select this option, the customer automation system 300 may present some relevant deals that are identified from a database of deals.

In accordance with other embodiments, the customer automation system 300 may provide ‘end of deal’ notifications. In such cases, the customer is informed about the ending of deal, contract, business arrangement, or the like. For example, a customer may be notified about the ending of an internet package deal with their current internet service provider (ISP). The customer may be presented with the best deals offered by their current ISP and the best deals offered by other ISPs. Continuing with this example, the customer automation system 300 may offer specific deals without requiring communication with the contact center, such as a call-in to the relevant customer service department. Pricing may also be shown along with other comparisons relevant to the customer. For example, promotional offers may be compared to the average usage of the customer (e.g., based on the customer profile) and current pricing of their plan. Other suggested options that are specific to the customer intent in the notification may also be presented, such as a “cancel service” option and an option to “search more deals.” Should the customer select the “cancel service” option, the customer automation system 300 may send a cancellation request to the contact center automatically. The customer automation system 300 may also search for more deals which fit the customer's needs and present these whether the customer has selected to cancel their service or just search for additional deals. These may also be presented to the customer.

According to other embodiments, the customer automation system 300 may monitor statements made by the contact center agent and automatically offers guidance to the customer in real-time. For example, the customer automation system 300 converts the contact center agent's speech to text using the speech-to-text converter 342 and processes the text using the natural language processing module 310. In exemplary embodiments, the natural language processing module 310 detects when the agent is making an offer and compares it to a database of other offers made by agents of the organization that the customer is speaking with. This database of other offers is crowdsourced from other customers. After identifying a corresponding matching offer in the database, the ranking of the offer compared to other offers is identified in order to determine whether the agent could make a better offer.

According to still other embodiments, the customer automation system 300 may present information to the customer about prior interactions with a particular contact center or organization. For example, such information may be retrieved during an ongoing interaction to show the current agent what other agents have said.

### Customer Privacy Automation

Embodiments of the present invention further include the personal bot 405 and related resources functioning to automate aspects related to privacy for a customer. More particularly, the customer automation system 300 of the personal bot 405 may allow customers to manage privacy or data sharing with organizations and corresponding contact centers.

In accordance with exemplary embodiments, for example, the customer automation system 300 may facilitate the customer managing settings for privacy and data sharing (or simply “data sharing settings”) globally, for example, across all providers and data types. The customer is enabled to manage data sharing settings on a per-organization basis by choosing which data type to share with each specific organization. As another example, the customer is enabled to manage data (e.g., data within a customer profile) according to data type. In such cases, the customer may choose which organization or which types of organizations to share each particular data type. In more detail, each field of data in the customer profile may be associated with at least one permission setting (e.g., in exemplary embodiments, each field of data may have a different permission setting for each provider). Further, user interfaces may be provided through the customer device 205 that allow the customer to adjusting data sharing settings and/or permission settings. Within such user interfaces, data sharing settings or permission settings may be made adjustable on a per data type, per organization basis, per type of organization basis, etc.

In accordance with exemplary embodiments, the customer automation system 300 may offer a plurality of levels for data sharing settings or permission settings. For example, in one embodiment, three different levels of permission settings are offered: share data, share anonymous data, and do not share any data. Anonymous data may include, for example, genericized information about the customer such as gender, zip code of residence, salary band, etc. Some aspects of embodiments of the present invention may enable compliance with the General Data Protection Regulation (GDPR) of the European Union (EU). In other embodiments, the customer automation system 300 provides functionality for a customer to exercise the “right to be forgotten” with all organizations (e.g., providers and/or business) that the customer has interacted with. In other embodiments, the customer can switch on/off the sharing of each of the data types. When selecting a specific data type, the customer can select to send this data in an anonymized form to the provider or to delete the previously shared data with a particular organization. Additionally, the customer can delete all data types that were previously shared with an organization, for example, by clicking on the ‘trash’ button provided in the customer interface. According to one embodiment of the present invention, the deletion of the data may include the customer automation system 300 loading an appropriate script from the script storage module 320 in order to generate a formal request to the associated organization to delete the specified data. As noted above, for example, the customer automation system 300 may be used to make such request by initiating a communication with a live agent of the organization or by accessing an application programming interface provided by the organization.

### Post-Interaction Automation

Embodiments of the present invention include methods and systems for identifying outstanding matters or pending actions for a customer that need additional attention or follow-up, where those pending actions were raised during an interaction between the customer and a contact center. Once identified, other embodiments of the present invention include methods and systems for automating follow-up actions on behalf of the customer for moving such pending actions toward a resolution. For example, via the automation resources disclosed herein, the personal bot 405 may automate subsequent or follow-up actions on behalf of a customer, where those follow-up actions relate to actions pending from a previous interaction with a customer service provider. For more information regarding such embodiments, reference is also made to the disclosures provided in U.S. application Ser. No. 16/730,646, filed on Dec. 30, 2019, entitled “System and Method Relating to Customer Experience Automation”, the content of which is incorporated herein by reference.

### Personalized Customer Profiles

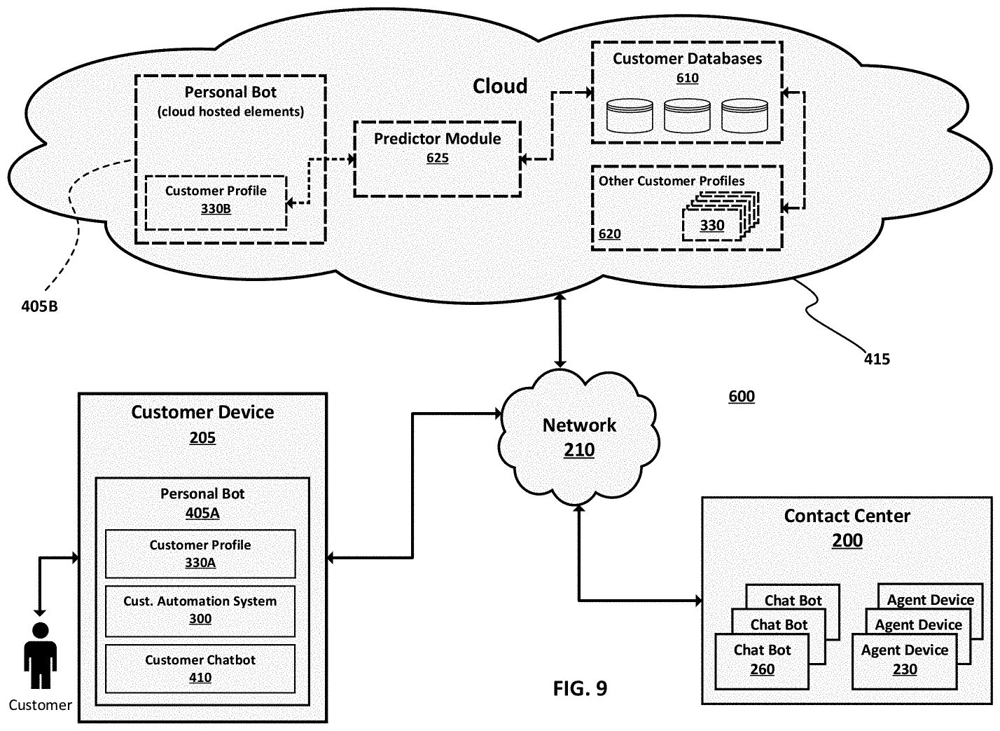

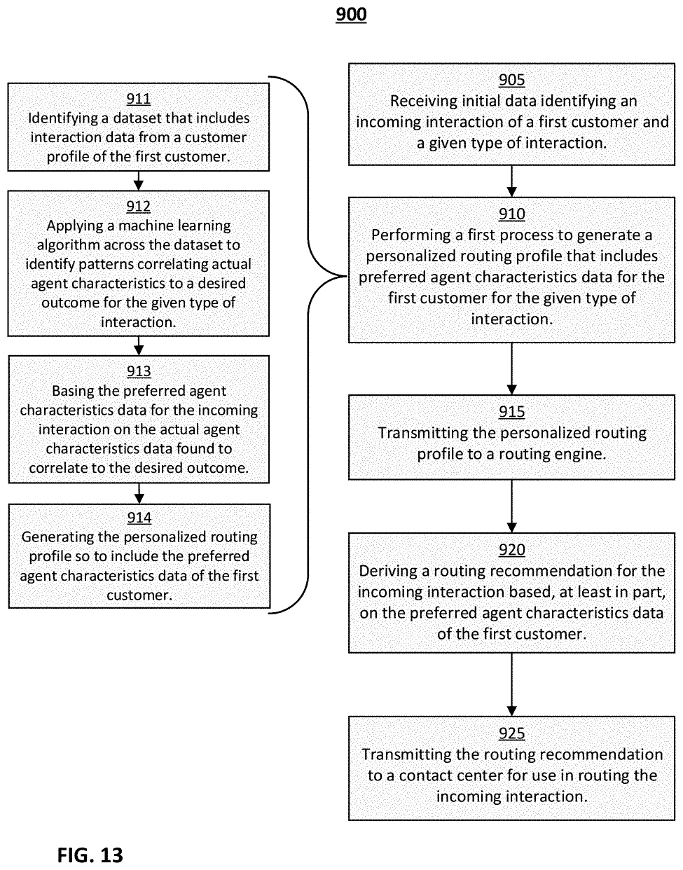

With reference now to FIGS. 9 and 13, attention will now focus on aspects of the present invention aimed at gathering, maintaining, analyzing, and using customer data and profiles. For example, systems and methods are disclosed for building highly personalized customer profiles that facilitate the mining and use of customer data. As will be seen, the customer profiles of the present invention may be used in several ways, including implementing personalized customer services aimed at improving the customer experience.

By way of background, customer service providers or contact centers have long maintained data on customers, with data pertaining to a particular customer often being stored in a customer profile. Once stored, this data then may be used by the contact center to manage certain aspects of the customer relationship. For example, contact centers may use customer profiles to facilitate aspects of incoming interactions. However, conventional customer profiles are often limited in scope, for example, including only basic information about customers, with perhaps some partial history and preferences. Further, conventional customer profiles have been structure and utilized in ways that have constrained customer-oriented advances. In several ways, which will now be touched on, conventional systems and methods associated with customer data and profiles have proved inadequate at providing the level of personalization required to deliver advanced customer-oriented functionality.

First, conventional customer profiles are overly static. That is, in conventional systems, customer profiles are not regularly updated and, thus, generally ill-equipped at providing helpful real-time clues as to a particular customer's present situation. What's more, conventional systems are often not configured to take into account the most current or relevant customer data, and this deficiency undermines the usefulness of customer behavior models and other analytics. Second, while advances in data collection and analysis have increased the amount and variety of data being collected about customers and interactions with contact centers, conventional systems have failed to leverage this new data abundance into customer centric features. For example, large repositories of customer interaction data could be analyzed to determine predictive insights useful at providing personalized customer services, yet conventional systems continue to emphasize the use of such data toward improving contact center performance, virtually ignoring the customer experience. Third, conventional systems also fail to properly aggregate data sources. As will be appreciated, opportunities to make cross-category data insights are impeded when different types of customer data are maintained in separate databases. Further, incomplete customer profiles degrade the ability of the enterprise to respond to and service customers according to particular needs. As a result of these and other issues, current data systems related to the maintenance, analysis, and use of customer data and profiles have been unsuccessful at promoting customer-oriented advances in the field. This failure is particularly apparent in those instances where the delivery of new services involves recognizing or predicting a customer's current status or emotional state.

To address this situation, the present invention discloses improved systems and methods for gathering, maintaining, analyzing, and using customer data and profiles. For example, systems and methods are disclosed for building highly personalized customer profiles that facilitate the analysis and mining of customer data. From there, the customer profiles of the present invention may be used in several ways, including implementing personalized customer services aimed at improving the customer experience and/or removing the interaction “friction” that normally occurs between customers and contact centers. On the customer-side of the interaction, for example, routing strategies can become more personalized in accordance with specific customer preferences and a present emotional state, thereby making routing more customer centric. On the contact center-side of the interaction, the present customer profiles also may be used toward improving contact center operations, such as, for example: making call forecasting more context oriented and reliable; improving handle time predictions and queue optimization; improving outbound campaigns (e.g., by targeting customers who are more likely to see value in and respond positively to a particular offer); improving agent assists or automated processes with more customer personalization (e.g., by anticipating customer needs to reduce the steps needed to complete an interaction and/or alleviate need for customer to provide information during an interaction); and improving customer communications through greater personalization.

Before proceeding, several terms will first be presented and defined in accordance with their intended usage. As used herein, “customer experience” generally refers to the experience a customer has when interacting with a customer service provider and, more specifically, refers to the experience a customer has during an interaction, i.e., as he interacts with a contact center. As used herein, “customer data” refers to any information about a customer that can be gathered and maintained by a customer service provider. As provided below, such customer data may be categorized with reference to several different information types. In discussing how such data is stored, reference may be made to a “customer profile” (such as customer profile 330), which, as used herein, refers a collection or linking of data elements relevant to a particular customer. Reference may also be made to “customer databases” (such as customer databases 610), which, as used herein, refers to a collection or linking of data elements relevant to or gathered from a large population of customers (or “customer population”). Further, as stated, reference may be made interchangeably to contact center or customer service provider. It should also be understood that, unless otherwise specifically limited, reference to a contact center includes reference to the associated organization or enterprise on behalf of which the customer services are being provided. This includes arrangements in which the associated organization or enterprise is providing the customer services through an inhouse contact center as well as arrangements in which a third-party contact center contracts with the organization or enterprise for providing such services.

With specific reference to FIG. 9, an exemplary system 600 is shown that includes a personal bot 405 running on a customer device 205, where the personal bot 405 facilitates the creation and maintenance of a personalized customer profile database or module (or simply “customer profile”) 330. As shown in the example, the customer profile 33 may include elements 330A local to the customer device 205 as well as remote or cloud hosted elements 330B. The system 600 may further include customer databases 610, other customer profiles 620, and a predictor module 625. (Note that further information in regard to the system 600 of FIG. 9 may be found above in relation to the system 400 of FIG. 8, which includes several similar features that are not described again here for brevity's sake.)

For the sake of an example, a customer may have a mobile device or smart phone on which is running an application implementing local aspects of the personal bot 405. In setting up a customer profile 330, the personal bot 405 may serve as a means for the customer to input information. For example, the personal bot 405 may prompt and accept direct input of information from the customer by voice or text. The customer may also upload files to the personal bot 405 or provide the personal bot 405 with access to pre-existing databases or other files from which information about the customer may be obtained.

The personal bot 405 also may gather information about the customer by monitoring customer behavior and actions through the customer's use of the device 205. For example, the personal bot 405 may collect data that relates to other activities that the customer performs through the device, such as email, text, social media, internet usage, etc. The personal bot 405 also may monitor and collect data from each of the interactions the customer has with customer service providers, such as a contact center system 200, through the customer device 205. In this way, data may be collected from interactions occurring with many different contact centers.

In use, at the conclusion of each interaction, the personal bot 405 of the present invention may update the profile of the customer in accordance with data gleamed from that interaction. Such interaction data may include any of the types of data described herein. As discussed more below, once the profile is updated, it will include data associated with that most recent interaction as well as data from other past interactions. This updated or current dataset then may be analyzed in relation to one or more customer databases 610, which, as used herein, are data repositories housing customer data, such as interaction data relating to past interactions, from a large population of other customers. The analysis may be performed with the predictor module 625, which may include a machine learning algorithm that is configured to find data driven insights or predictors (or, as used herein, “interaction predictors”).

As used herein, the interaction predictors represent a behavioral factor attributable to the customer given the first interaction type. As will be seen, the behavioral factor of the interaction predictor may include an emotional state, behavioral tendency, or preference for a particular customer given a type of interaction (also “interaction type”). The interaction predictor may be generated and applied in real time, for example, by the predictor module 625. Alternatively, the interaction predictors may be determined and stored in the customer profile 330 of a given customer as a way to augment or further personalize the profile. Such stored interaction predictors then may be applied in future interactions involving the customer when found relevant thereto. The predictor module 625 may be a module within the personal bot 405 or, as illustrated, may be a separate module that communicates with the personal bot 405.

Thus, in general, a personal bot 405 may gather relevant information as a customer interacts with contact centers on his mobile device. The personal bot 405 may gather other types of information, as described above, and then may aggregate that data to build a highly personalized customer profile 330. As will be appreciated, when a customer profile is created and maintained by a contact center, it is generally limited to data pertaining to past interactions occurring between a customer and a particular contact center. In the present invention, with the customer profile 330 being created and maintained on the customer-side of the interaction, the collection of data is not so limited. Instead data may be gathered from any of the interactions involving the customer, which will typically result in a much richer set of data as it reflects a wider spectrum of interactions.

The system of FIG. 9 may include a collection of data that is referred to other customer profiles 620. As will be appreciated, when versions of the personal bot 405 are used by many customers, data may be anonymously gleaned from the many corresponding customer profiles 330 (as shown within the other customer profiles 620) so to create rich repositories of customer data. For example, such data repositories may include information taken from a multitude of past interactions covering a wide spectrum of both customers and customer service providers. As indicated, this data may be parsed and aggregated into the customer databases 610 so to provide particular datasets that facilitate machine learning and other data driven analytics.

While the customer profiles 330 of the present invention may include any type of customer data, exemplary embodiments may include several primary categories of information. These categories include: biographic personal data (or simply “personal data”); past interaction data (or simply “interaction data”); feedback data; and choice data. As will also be seen, present systems and methods may predict or infer certain behavior traits, preferences, or tendencies about a customer through data analytics. Such predictions—which are introduced above as “interaction predictors”—may also be stored within a customer profile 330 and then utilized in subsequent interactions as a way of enhancing personalization and facilitating other customer centric features. Alternatively, the interaction predictors may be generated contemporaneously and used in relation to an incoming interaction.

It should be appreciated that, while the data stored within the customer profile 330 may be discussed in categories, the customer profile 330 of the present invention may be structured to include an aggregated collection of information that may be analyzed as a whole. Further, it should be understood that the data within a customer profile 330 may be stored locally on a customer device 204, remotely in the cloud, or some combination thereof. Present systems and methods may further include functionality that protects a customer's data from unwanted disclosure. In general, the data stored within the profile of a customer is controlled by the customer, with the customer deciding what information is to be shared during each interaction with an outside organization or enterprise. Thus, before any customer profile data is shared with an outside entity, such as a contact center or other organization, present systems and methods may first seek to confirm with the customer that such sharing is intended. Additional functionality may enable the partial sharing and use of customer information in ways that maintain a customer's anonymity.

In regard to the types of data stored within a customer profile 330, a first category is referred to herein as personal data. This type of data may include general information about the customer that is generic to all interactions with customer service providers, for example, name, date of birth, address, Social Security number, social media handles, etc. This type of data may also include biographical information, such as education, profession, family, pets, hobbies, interest, etc. This category of data may also include data that is specific to particular contact centers. For example, data related to authentication information specific to the different companies that the customer does business with, including usernames and passwords, may be included. Such personal data may be added to a customer profile 330 when a customer is registering with or setting up the mobile application, i.e., personal bot 405, on his mobile device. For example, a prompt by the personal bot 405 may be provided that initiates input of the necessary information. When setting up the mobile application, the customer may be asked via a user interface generated on his customer device for certain information. Once gathered, the personal data of the customer may be made part of the customer's profile. The customer may update this information at any time. As will be seen, aspects of the personal data may be used to find similarities with other customers, which may be used when making predictions about the customer.

The customer profile 330 of the present invention further may include a category of information referred to herein as past or historical interaction data (or simply “interaction data”). As used herein, this refers to data pertaining to or measuring aspects of previous customer interactions. Accordingly, such data may include a complete historical record of data reflecting all past interaction between a customer and any contact center. Interaction data may include any of the types of information described herein relating to interactions, including type or intent of the interaction, information associated with the dialogue between the agent and customer, such as a recording or transcript, information related to the agent, including agent type and other characteristics, information about results of the interaction, notes provided by the customer or the agent, files shared during the interaction, length of the interaction, call transfers or holds that took place during the interaction, emotional state of the customer, and others. The customer profile 330 may be updated after each new interaction with such interaction data taken therefrom. The interaction data may further include feedback data and choice data, which are discussed below.

The customer profile 330 of the present invention further may include feedback data, which, as used herein, refers to feedback received from a customer that relates to a particular interaction with a contact center. As will be appreciated, feedback and survey responses may provide a valuable indication as to what went right or wrong in an interaction. Often such feedback is provided by customers at the end of an interaction in response to surveys or ratings requests. In accordance with the present invention, any type of feedback, including customer satisfaction score or ratings, provided by a customer at the conclusion of an interaction is saved within a customer profile 330 as feedback data. Systems and methods of the present invention may include functionality wherein the personal bot 405 gathers such feedback data for storage within the customer profile 330. The personal bot 405 may do this via passively recording such feedback when provided by the customer in response to a query initiated by an outside entity, such as a contact center. The personal bot 405 also may actively prompt for such feedback at the end of an interaction and record any responses provided by the customer.

Another type of feedback data may include what will be referred to herein as “conclusory statement data”. Conclusionary statement data may include data related to statements made by a customer as the interaction is concluding, where the meaning of the statements is extracted by natural language processing. Conclusory statement data, thus, may be seen as a type of inferred feedback, i.e., feedback inferred from statements made while the interaction is concluding.

For example, the personal bot 405 may gather such conclusory statement data by analyzing statements or comments made by the customer at the conclusion of an interaction and, where appropriate, inferring customer feedback from the analysis of those statements. Specifically, such conclusory statements by the customer may be extracted and analyzed via natural language processing and, when the customer's statements are clear enough to infer feedback with sufficient confidence, the inferred feedback may be gathered for storage within the customer profile 330 as a type of feedback or interaction data. As such statements are often highly relevant as to how the customer feels at the conclusion of an interaction, such inferences can prove useful, particularly where no other rating or survey response is provided by the customer for a given interaction. According to exemplary embodiments, for example, such feedback data may be used to assist contact centers in deciding on the level of service that a customer should receive in a next interaction.

The customer profile 330 of the present invention further may include choice data, which, as used herein, refers to data that relates to a selection or choice made by the customer in selecting an agent. More specifically, choice data refers to automatically learned preferences of the customer that are based on the customer's manual selection of one agent or type of agent over another agent or type of agent. For example, the present invention may include functionality that permits customers to manually choose their own agent from alternatives provided to them via the customer's computing device. Thus, a customer may be allowed to review a collection of agent profiles of available agents and then prompted to select one of those agents to handle the customer's present or incoming interaction. Alternatively, instead of being presented with a choice between individual agents, the customer may be prompted to select from different categories or types or agents. The categories, for example, may describe personality types of the agents. After the customer makes several such selections, systems and methods of the present invention could begin to learn what type of agent a customer most and least prefers. In example embodiments, such learning can be bolstered by cross-referencing interaction data that describes the actual outcomes of those interactions and/or subsequent feedback provided by the customer. In certain cases, this type of analysis may produce insights into preferences that even the customer is not fully aware of having, which may be leveraged to improve predictive routing for that customer in future interactions.

The data stored within the customer profile 330 of the present invention may further include interaction predictors. As used herein, an interaction predictor is defined as a behavioral characteristic, preference, tendency, or other customer trait that, because of correlations or patterns found to exist within a dataset of relevant customer information, can be inferred upon or attributed to a given customer. As will be seen, some interaction predictors may be used to predict broad traits, behaviors, or tendencies that are common to many other customers, while other interaction predictors are highly contextual and specific to particular type of interaction, such as, for example, interactions involving a particular intent, emotional state, or contact center. As will be appreciated, the interaction predictors of the present invention offer a way to add detail to a customer profile 330 with assumed characteristics that then may be used to personalize services and facilitate interactions.

In deriving the interaction predictors, any of the systems and methods described herein may be used. In exemplary embodiments, as shown in FIG. 9, the personal bot is configured to communicate with a predictor module 625 that includes an artificial intelligence or machine learning algorithm. As will be appreciated, the machine learning algorithm may be applied to a dataset of customer information and, therefrom, learn knowledge in the form of data patterns correlating one or more input factors to one or more outcomes, with those correlations forming the basis of the interaction predictors. For example, the machine learning algorithm in the predictor module 625 may extract such patterns based on monitored customer actions and associated outcomes. Once such knowledge is acquired, it may be put to use in the form of the present interaction predictors to predict outcomes when new inputs are encounters, such as those presented in an incoming interaction.

Any one or more existing machine learning algorithms may be invoked to do such learning, including without limitation, linear regression, logistic regression, neural network, deep learning, Bayesian network, tree ensembles, and the like. For example, linear regression assumes that there is a linear relationship between input and output variables, whereas, in the case of neural networks, the learning is done via a backward error propagation where the error is propagated from an output layer back to an input layer to adjust corresponding weights of inputs to the input layer.

For the sake of providing examples as to how such interaction predictors may be derived for a given customer, reference will now be made to an exemplary customer “Adam”. To begin the process, the machine learning algorithm of the predictor module 625 may be configured to monitor a given dataset. This dataset may be obtained from any of the several sources of data described herein. For example, one or more data sources may be derived from data maintained within Adam's own customer profile (i.e., customer profile 330). The machine learning algorithm may have access to and monitor several of the types of data stored within Adam's customer profile, e.g., the personal data, interaction data, feedback data, and/or choice data.

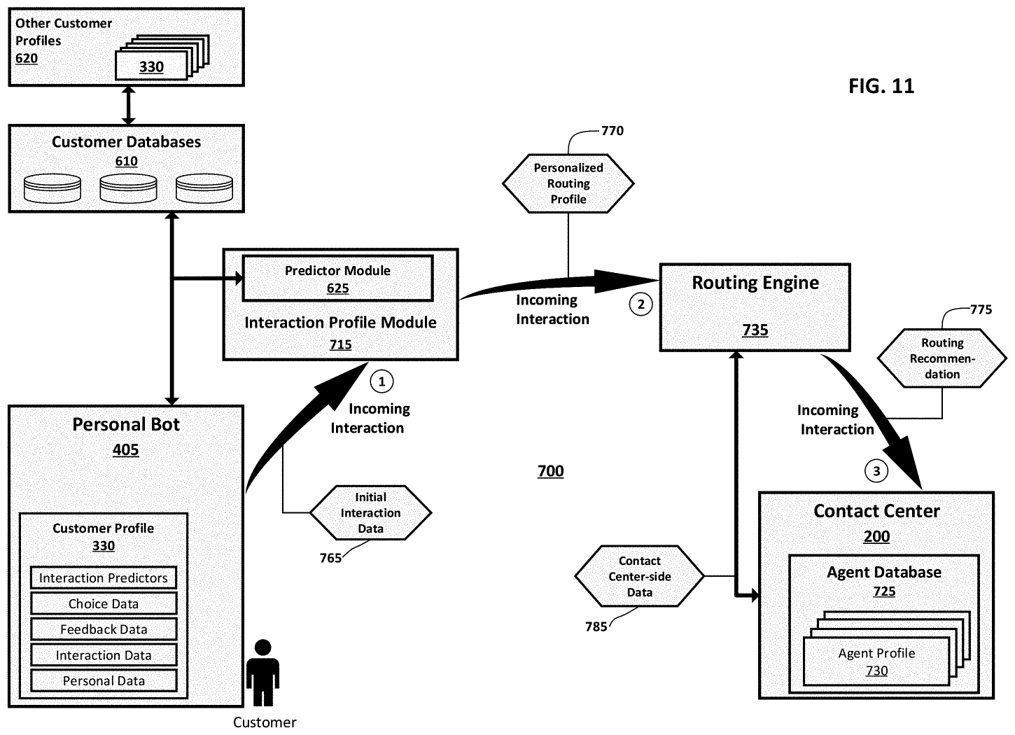

For example, to gain insights on what works best for Adam during interactions, the machine leaning algorithm could monitor (i.e., use as a training dataset) Adam's interaction data and identify particular factors that consistently correlate with more successful outcomes. As a more specific example, the machine learning algorithm of the predictor module 625 may monitor the choice data within Adam's customer profile—i.e., the agents that Adam selects when given a choice—to identify patterns relating to the type of agents Adam prefers. Once identified, such a pattern could become the basis for an interaction predictor, which the predictor module 625 would then cause to be stored within the Adam's customer profile. When circumstances later arise that are relevant to the interaction predictor, the interaction predictor could be recalled from Adam's customer profile and used to facilitate choices as to how best to provide services to Adam. Specifically, for example, the interaction predictor could be used to predict which agent out of those available would be most preferable to Adam, as will be discussed more below in relation to FIG. 11.

In accordance with other aspects of the present invention, the machine learning algorithm of the predictor module 625 may also monitor and derive datasets from one or more customer databases 610, which, as used herein, refer to a collection of customer data gathered from “other customers”. For example, the customer databases 610 may include data gathered from a large customer population. Such customer databases 610 may store any of the customer data types discussed herein and include a multitude of samples collected from a customer population. As an example, one of the customer databases 610 may include data aggregated from the personalized customer profiles of the present invention, where those customer profiles 330 correspond to customers within a customer population (with those customer profiles 330 being represented by those depicted within the other customer profiles 620).

In accordance with an exemplary embodiment, the machine learning algorithm may monitor or derive training datasets from the customer databases 610, such as a dataset that includes interaction data taken from previous interactions between customers within the customer population and different contact centers. The machine learning algorithm may then analyze the data within this database to identify patterns in which particular factors consistently correlate with certain outcomes. As before, such patterns or correlations may then become the basis for identifying interaction predictors. Thus, based on similarities found to exist between Adam and the other customers within the customer population, the predictor module 625 may cause one or more interaction predictors to be applied to or used in connection with Adam.

When identified from a large database of customer information, interaction predictors may be found to be predictively relevant to the customer population as a whole or to a group or subpopulation defined within the customer population. Thus, in accordance with the present invention, the applicability of such interaction predictors to any particular customer, such as Adam, may be predicated on a degree of similarity found to exist between Adam and a given subpopulation. Thus, the predictor module 625 may attribute such an interaction predictor to Adam only after determining that a sufficient degree of similarity exists between Adam and the customers within the corresponding subpopulation or, put another way, whether Adam is determined to be member of that subpopulation. Upon determining that a sufficient level of similarity exists between Adam and that subpopulation, the predictor module 625 may add the particular interaction predictor to Adam's customer profile, where it will remain until further machine learning makes necessitates its modification or removal.

As a general example, a customer database 610 that stores interaction data may include data collected from interactions between a customer population and many different contact centers. A predictive correlation or other data driven insight—generally referred to herein as an interaction predictor—is then identified via the machine learning algorithm of the predictor module 625 by monitoring and analyzing the customer database 610. Through this analysis, it may further be determined that the identified interaction predictor is only applicable to a particular subpopulation within the customer population. In accordance with the present invention, the interaction predictor then is selectively applied to a particular customer if it is determined that the customer is a member of the given subpopulation or, at least, sufficiently similar to another customer within the given subpopulation.

Whether gleamed from the customer's own past behavior, based on the past behavior of other similar customers, or some combination thereof, once determined, the interaction predictors may be applied to a particular customer (for example, saved within his customer profile 330) and then used to make certain insights or predictions about that customer in order to enhance aspects of customer service. As will be appreciated, the interaction predictors stored within a customer profile 330 may be dynamically updated as needed so that those currently stored reflect changes, updates, or additions to the underlying datasets. For example, in an interaction that just concluded, customer Adam made an agent selection that significantly modifies the choice data stored in his customer profile. According to exemplary embodiments, the machine learning algorithm may continue to monitor Adam's customer profile (and choice data included therein) and modify the interaction predictors in Adam's customer profile as needed given the modification to the underlying dataset (i.e., the dataset as modified by his recent interaction).

Changes to data within the customer databases 610 may also modify how interaction predictors are applied to Adam. For example, the addition of new interaction data within a customer database may modify interaction predictors that are identified therein. To the extent the modification impacts any of the interaction predictors found applicable to Adam, Adam's customer profile would be updated to reflect that. As another example, if Adam inputs new personal information, such as a change in professional status or where he lives, existing similarities between Adam and certain groups within the customer population may be altered. As those similarities change, the interaction predictors that are attributed to Adam or used in interactions involving Adam will be updated to reflect the changed similarities.

With the data and the interaction predictors stored in a given customer profile 330, aspects of the present invention may be used to facilitate the personalized delivery of customer services related to a present or incoming interaction. For example, contextual information or factors related to the incoming interaction may be identified and, based on those identified factors, predictions can be made about the customer by determining which of the stored interaction predictors are applicable. Alternatively, it should also be understood that such predictions about the customer may be made contemporaneously with the incoming interaction via the machine learning algorithm (or models developed therefrom) finding similarities in the contextual information around the incoming interaction and past interactions experienced by the customer and/or other similar customers within the customer databases 610. In either case, one or more interaction predictors applicable to the incoming interaction may be used to facilitate the delivery of services to the customer during the incoming interaction.

In accordance with exemplary embodiments, the relevant interaction predictors along with any other relevant information from the customer profile 330 may be packaged within an interaction profile and then delivered to a contact center for use thereby. As will be seen, the contact center may then use this package data or interaction profile to facilitate decisions as to the nature of services that should be provided to the customer during the incoming interaction. Embodiments will now be discussed covering exemplary implementations as to how this information may be used. For the sake of these example, reference again may be made to customer Adam.

In accordance with a first example, systems and methods of the present invention may be used to predict a customer's emotional state in the incoming interaction. For example, based on the series of interactions that Adam has experienced, interaction predictors may be developed that relates such interactions to a pattern of emotional states, which may be gleaned from analyzing interaction transcripts for language indicative of particular emotional states. A customer's emotional state, for example, may vary in accordance with a predictable pattern that relates to factors such as: intent of the interaction; recent unsuccessful efforts to resolve the same issue; unfavorable history with a certain enterprise; etc. By learning these patterns using the systems and methods disclosed above, it now becomes possible to make predictions as to the emotional state that the customer is likely to exhibit in the next incoming interaction.

For example, Adam calls Best Buy to enquire about an online order that he placed last week for an iPhone. Best Buy, as a retailer, answer Adam's question, but tells him that the order was placed with Apple. Best Buy gives Adam with an order identification number and redirects him to a customer service provider associated with Apple. Adam, now connected with Apple, is told by an agent that his order has been fulfilled and sent to FedEx for shipment. The Apple agent further provides a reference shipping number for tracking the order. With this new information, Adam goes to the FedEx webpage, however he finds that the tracking information fails to provide any information about his order. Adam now calls FedEx to inquire about it. After being on hold for several minutes, a FedEx agent finally informs Adam that FedEx has not received the requested order from Apple and that the tracking number he has been provided is incorrect. Adam now instigates another interaction—referred to as an incoming interaction for the sake of describing functionality—with Apple. Each of these interactions are done through a customer device of Adam that has a personal bot 405 in accordance with the present invention.

The personal bot 405 of the present invention may be tracking the interactions Adam has instigated with the customer service providers associated with Best Buy, Apple, and FedEx. Using systems and methods described herein, Adam's customer profile may be updated with each of these interactions as they happen and, through natural language processing of transcripts and other available information relating to the interactions, the personal bot 405 may become aware that: a) the situation involves several interactions relating to common subject matter (i.e., the same problem); b) that Adam has already initiated several recent interactions with different enterprises in an effort to resolve that problem; and c) Adam has so far been unsuccessful and the issue remains unresolved.

To continue the example, the predictor module 625 may have gleamed several interaction predictors that are relevant to this situation. As described above, these may have been determined via analyzing (e.g., by using a machine learning algorithm) data associated with Adam's own past behavior and/or the behavior of a population or group of other customers that are similar to Adam in ways found to be predictively relevant. The applicable interaction predictors, for example, may predict that the situation is one that likely would induce a particular emotional state for the customer, such as negative emotions like anger or frustration. Thus, by using information stored within the Adam's customer profile and recognizing the number and subject matter of Adam's recent interactions, a prediction can be made as to Adam's emotional state coming into the incoming interaction that Adam just initiated with Apple. Specifically, it can be predicted that Adam will likely be angry or frustrated. This type of insight then can be used in several ways to tailor the service Adam receives once he connects with Apple. For example, as will be discussed more below, this prediction may be used to select an agent that is more adept at handling interactions with frustrated or angry customers.

Related to the above example, systems and methods of the present invention can also be used to facilitate a proactive engagement by a customer service provider or contact center. That is, given the above-described pattern of recent interactions logged within Adam's customer profile, the personal bot 405 of the present invention can predict not only that Adam is angry or frustrated, but also that the issue remains unresolved and that Adam will soon be contacting Apple again as he tries to find a resolution. With these types of predictions, the personal bot 405 can also include functionality whereby a particular enterprise (Apple in this case) is notified that Adam's issue remains unresolved and Adam will likely be trying to contact Apple again. This type of information could then prompt Apple to proactively initiate the next interaction before Adam does. As will be appreciated, this type of proactive step by an enterprise would go long way toward repairing a customer's negative feelings, while also facilitating a resolution to an ongoing issue. Which is to say, if it can be predicted that a customer's issue remains unresolved and the customer is likely to instigate another interaction soon, it may be very favorable from a customer relationship perspective for the enterprise to be the party that instigates that next interaction. With personal bot's extensive customer data covering multiple enterprises and multiple intents, these predictions on upcoming interactions can be made and the given enterprises conveniently notified.

Taking further advantage of the systems and methods disclosed herein, the personal bot 405 may be able to compute a severity rating for an incoming interaction. As used herein, a severity rating for an interaction is a prediction as to how serious or important an interaction is to a customer. Conventional contact centers typically predict a severity or importance for an incoming interaction based upon the intent of the interaction. For example, for any incoming interaction with an intent determined to be “stolen credit card”, a severity rating of “high severity” (i.e., high level of importance) is allocated. As another example, for an incoming interaction with an intent determined to be “forgotten password”, a severity rating of “moderate severity” (i.e., moderate level of importance) is allocated.

Similar to the process described above in relation to predicting emotional state, present systems and methods may learn to personalize severity ratings for particular customers based on the pattern of interactions stored in the customer profile 330 and interaction data for similar customers. As before, learned interaction predictors may apply specifically to a particular customer, such as Adam. Along with intent, such interaction predictors may take into account other factors, such as, for example, time of the day, type of enterprise, recent interactions, and the emotional state of the customer. With this information, the personal bot 405 can tailor severity ratings for incoming interactions for particular customers. As will be appreciated, different customers may view the same type of interaction with varying levels of importance. With the present invention, these varying levels may be determined, and service levels varied accordingly.

The systems and methods of the present invention also may be used in similar ways to make other useful predictions related to incoming interactions, which then may enable improved customer service. As discussed more below, a first of these include using the customer profile 330 of the present invention to personalize routing decisions for customers.

As another example, based on the customer profile 330 (and interaction predictors stored therewithin) as well as the intent and other contextual factors related to the incoming interaction, the personal bot 405 can make predictions regarding the likelihood of success of upselling and/or cross-selling opportunities available to the given enterprise or contact center. As an example, certain customers may be determined to be more approachable than others with upselling or cross-selling offers. As another example, a customer's emotional state could be a factor that is found to correlate with the success of upselling or cross-selling opportunities. Specifically, an angry or frustrated state may negatively impact the likely success of attempts to upsell or cross-sell a customer. Indeed, it may be found that, in certain situations, the attempt to upsell or cross-sell such customer only serves to make the customer angrier or more frustrated. It will be appreciated that contact centers could apply such insights toward making more productive routing decisions. For example, those incoming interactions that rate well in regard to upselling or cross-selling opportunities could be steered to agents that perform better in this area.

As another example, the present systems and methods may be used to predict a preferred communication channel for an incoming interaction, with the preferred communication channel being the channel offering the best chance for successful resolution given the customer. As before, based on the customer profile 330 (and interaction predictors stored therewithin) as well as the intent and other contextual factors related to the incoming interaction, the personal bot 405 can predict a preferred communication channel for initiating an interaction with the contact center. As another example, if a customer has reached out to his bank about a forgotten password, the personal bot 405 could redirect the interaction to a self-service portal which is configured to instantly resolve this kind of interaction. In this way, the customer can avoid the wait to be connected with agent that is unnecessary.

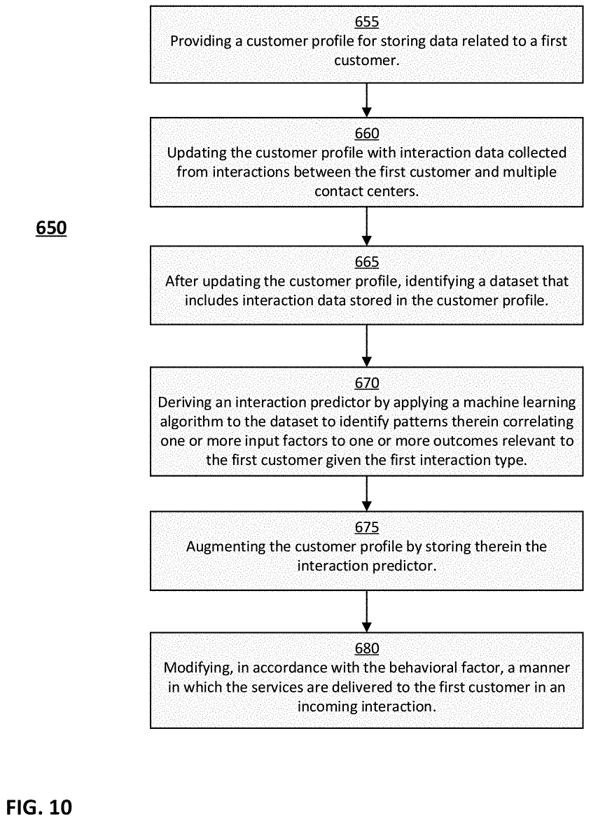

With reference now to FIG. 10, a method 650 is shown for personalizing a delivery of services to a customer (which, for clarity, will be referred to as a “first customer”) via a personalized customer profile. The first customer may have a communication device, such as a smart phone, through which interactions with several contact centers are conducted.

As an initial step 655, the method 650 includes the step of providing a customer profile for storing data related to the first customer.

At a next step 660, the method 650 includes the step of updating the customer profile via performing a data collection process to collect interaction data related to the interactions between the first customer and contact centers. The data collection process may be performed repetitively so to update the customer profile after each successive one of the interactions. Described in relation to an exemplary first interaction between the first customer and a first contact centers, the data collection process may include the steps of: monitoring activity on a communication device of the first customer and, therefrom, detecting the first interaction with the first contact center; identifying data relating to the first interaction for collecting as the interaction data; and updating the customer profile to include the interaction data identified from the first interaction. The contact centers involved in the interactions from which the interaction data is collected may include multiple different contact centers.

At a next step 665, the method 650 includes the step of identifying a dataset for deriving an interaction predictor. The dataset may be based, at least in part, from the data stored within the customer profile. More specifically, the dataset may include the interaction data stored in the customer profile.

At a next step 670, the method 650 includes the step of deriving an interaction predictor by applying a machine learning algorithm to the dataset to identify patterns therein correlating one or more input factors to one or more outcomes relevant to the first customer given a particular type of interaction, which, for the sake of clarity, will be referenced as a “first interaction type”. As explained more above, the interaction predictor may be based on knowledge acquired by using a machine learning algorithm to “learn” a set of data or dataset. The knowledge may relate to a behavioral factor attributable to the first customer when encountering the first interaction type. According to exemplary embodiments, the behavioral factor of the interaction predictor is defined as an emotional state, behavioral tendency, or preference. Though other types of machine learning algorithms may also be used, exemplary embodiment include a neural network.

At a next step 675, the method 650 includes the step of augmenting the customer profile of the first customer by storing therein the interaction predictor. The storage of the interaction predictor may include linking the behavioral factor to the first interaction type to facilitate real time retrieval, for example, when for use in relation to a subsequent or incoming interaction that is the same as the first interaction type.

At a next step 680, the method 650 includes the step of modifying, in accordance with the behavioral factor, a manner in which services are delivered to the customer in an incoming interaction. For example, an incoming interaction instigated by the first customer may be detected as being the same as the first interaction type. In response this detection, the derived interaction predictor may be retrieved from the customer profile of the first customer, and, upon being retrieved, the relevant behavioral factor can be identified. The manner in which services are delivered to the first customer in the incoming interaction may be modified pursuant to the behavior factor. More specifically, once identified, the behavior factor may be transmitted to the contact center involved in the incoming interaction. The contact center may then use the insight provided by the behavior factor to modify the way it delivers services to the first customer in the incoming interaction.

The method 650 may be performed in accordance with several additional or alternative steps, which provide a range of functionality. Further, significant terminology of the process may be defined so to the basic methodology yields interaction predictors covering a range of applications. Examples of these alternatives will now be discussed.

In accordance with exemplary embodiments, the steps of the data collection process may be performed by an automated assistant software program or application, which will be referred simply as “automated assistant”. The automated assistant may operate on the communication device of the first customer. In example embodiments, the automated assistant is the personal bot described above. Further, the customer profile may be stored in cloud-hosted databases, which are updated by the automated assistant in accordance with the data collection process. As an example, the automated assistant may transmit the collected interaction data over a network to the cloud-hosted databases.

In exemplary embodiments, the behavioral factor of the interaction predictor is an emotional state attributable to the first customer given the first interaction type. The emotional state may be represented by at least one descriptor representative of either a negative emotional state or a positive emotional state. For example, the emotional state may be simple indicate a satisfied emotional state or an unsatisfied one. Other examples include positive emotional states, such as happy, calm, or thankful, and negative emotional states, such as angry, frustrated, confused, sad, or impatient. The interaction data included in the dataset may include data from the interactions evidencing the negative and positive emotional states. For example, the interaction data may include feedback data related to an evaluation, survey, or satisfaction score provided by the first customer after a termination of the interaction. The interaction data may include conclusory statement data related to statements made by the first customer as the interaction is concluding. As described earlier, this type of data may constitute an inferred type of feedback data. The meaning of such statements may be extracted by natural language processing.

When deriving the interaction predictors, the way in which the behavioral factor and first interaction type are defined may be varied in accordance with a desired functionality. For example, continuing with the behavioral factor being defined as an emotional state, the first interaction type may be defined as interactions having a particular intent. In such an embodiment, the resulting interaction predictor becomes a customer-specific prediction relating to an emotional state of the first customer for an incoming interaction having the particular intent. As another example, the first interaction type may be defined as interactions involving a particular contact center. In this type of embodiment, the resulting interaction predictor becomes a customer-specific prediction relating to an emotional state of the first customer for an incoming interaction involving the particular contact center. Related to this embodiment, the process for generating the interaction predictors may be repeated after successive iterations of the data collection process. This repetition may be done until the customer profile includes the interaction predictors predicting the emotional state of the first customer for interactions involving each of the contact centers that the first customer regular interacts with.

In accordance with exemplary embodiments, the characteristics attributed to the first customer via the interaction predictors may be accessed and modified by the first customer. For example, the automated assistant may generate user interfaces on a display of the communication device of the first customer that shows the emotional state data for one or more of the contact centers. The display may further prompt the first customer for input modifying the emotional state in any of the interaction predictors stored within the customer profile. To continue the example, the automated assistant may receive input from the first customer modifying the emotional state of one of the interaction predictors. The automated assistant may then update the emotional state of the interaction predictor in accordance with the input received from the first customer.

In another example, the emotional state of the interaction predictor may comprise a severity rating, which as explained above, rates a level of importance the first customer places on the first interaction type. With such embodiments, the interaction data included in the dataset may include data from each interaction evidencing the level of importance the first customer placed on it. The level of importance, for example, may be based, at least in part, on an analysis of an interaction transcript in which usage of words indicative of a high level of emotionality and/or a low level of emotionality is evaluated. In this case, if the first interaction type is defined by a particular intent, the resulting interaction predictor becomes a customer-specific prediction relating to a severity rating the first customer places on an incoming interaction having the particular intent.

Alternatively, the behavioral factor of the interaction predictor may be defined as a behavioral tendency attributable to the first customer given the first interaction type. For example, the behavioral tendency may include an upselling/cross-selling opportunity rating, which rates a willingness of the first customer to consider an upselling or cross-selling offer given the first interaction type. In this embodiment, the interaction data included in the dataset may include data from interactions describing unsuccessful upselling or cross-selling offers, successful upsell or cross-selling offers, and/or service or products purchased by the first customer in relation to upselling or cross-selling offers. As will be appreciated, in this case, if the first interaction type is defined by a particular intent, the resulting interaction predictor becomes a customer-specific prediction relating to an upselling/cross-selling opportunity rating for the first customer in an incoming interaction having the particular intent.

As another example, the behavioral factor of the interaction predictor may be defined as a preference, e.g., an agent preference, attributable to the first customer given the first interaction type. As described more below, the agent preference may include a preferred agent characteristic for the first customer given the first interaction type. With such embodiments, the interaction data included in the dataset may include choice data, the choice data including preferred agent characteristics derived from selections the first customer makes in the interactions when allowed to select an agent from among a plurality of offered agents. As will be appreciated, in this case, if the first interaction type is defined by a particular intent, the resulting interaction predictor becomes a customer-specific prediction relating to a preferred agent characteristic for the first customer in an incoming interaction having the particular intent.

In alternative embodiments, the method may include providing one or more customer databases storing data relating to other customers, such as interaction data relating to interactions occurring between such other customers and contact centers. In such embodiments, the derivation of the interaction predictor applicable to the first customer may be completed in accordance with a different process. For example, the interaction predictors may be generated by a process that includes the steps of: identifying a dataset that includes the interaction data stored within the one or more customer databases; deriving the knowledge of the interaction predictor by applying a machine learning algorithm to the dataset to identify patterns therein correlating one or more input factors to one or more outcomes relevant to a type of customer given the first interaction type; and attributing the interaction predictor to the first customer based shared similarities between the first customer and the type of customer. As explained in more detail above, the “type of customer” is representative of a subgroup of the other customers, with the members of the subgroup having one or more common characteristics found to be predictively relevant by the machine learning algorithm in regard to the generated interaction predictor. Further, the step of attributing the interaction predictor to the first customer may include the steps of: after the customer profile is updated by a completed iteration of the data collection process, identifying data within the customer profile relevant to the one or more common characteristics; and confirming that the one or more common characteristics are possessed by the customer. For example, the one or more common characteristics may relate to one or more respective characteristics stored within the biographical personal data of the customer profile. Further, in the same way as described above, the manner in which the behavioral factor and first interaction type are defined may be varied to produce similar alternative embodiments.

### Personalized Customer Routing

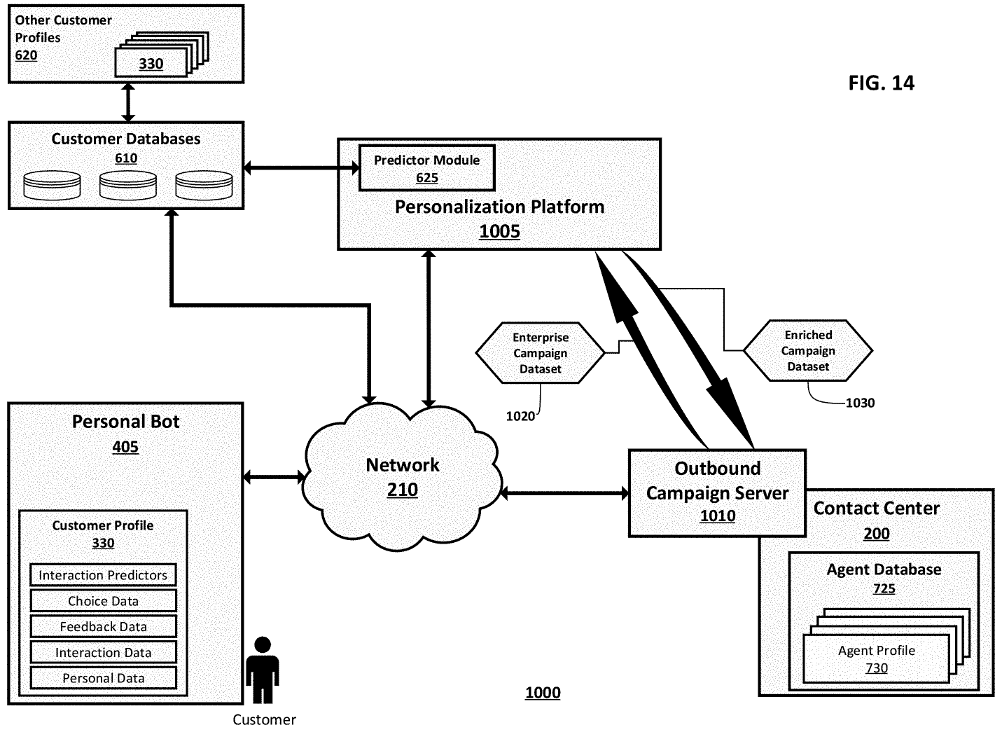

With specific reference to FIGS. 14-16, attention will now focus on aspects of the present invention aimed at improving automated systems for routing incoming interactions at a customer service provider. Specifically, systems will be presented that further personalize routing decisions by leveraging aspects of the customer profile 330 disclosed above. In this way, customer preferences can be better understood and then used to facilitate agent routing selections.

By way of background, contact centers have long used automated systems to desirably route incoming interactions to particular agents. Early routing systems (or “routers”) were primarily intent based. Such systems would simply match an incoming interaction to an available agent based on the intent of the query, with the intent being matched to a static description of an agent's skillset. Later, predictive routers were developed that used more sophisticated routing rules and models. In these systems, agents were rated in multiple performance categories, and those ratings were more regularly updated with results from recently handled interactions. The rating categories, for example, might include performance data such as first call resolution rate, average handle time, customer satisfaction rate, etc. An agent would be selected not only on the nature of the query and his skillset, but also on performance. While this represented an improvement in terms of routing calls to the best available agents, conventional routers still relied too often on stale data and largely ignore customer characteristics.

Customer profiles eventually were developed so that customer data was used in the routing process, but the data was limited, overly static, and ineffectively implemented. Advances in data collection soon increased the amount and variety of data being collected about customers and interactions. Such data could have proved valuable in finding insights that might prove useful in routing decisions. However, this new abundance of data has never been seriously applied in this way, as conventional routing systems remain focused on making routing decisions based on producing favorable business outcomes. In addition, conventional routing systems still do not sufficiently aggregate available data into routing models or use newly acquired data to regularly update customer profiles. When there is a lag between gathering and using customer data, customer models can no longer represent present conditions and prediction capabilities suffer. Conventional routers generally fail to take into account many factors associated with the customers that, otherwise, could be used to improve the routing and, thereby, the customer experience. For example, factors associated with a customer's emotional makeup and preferences as to agent personality have been largely ignored. As will be seen, the issues can be addressed by leveraging customer-side personalization to improve interaction routing.

With specific reference to FIG. 11, a system 700 is shown for using customer data to facilitate personalized routing decisions. As will be appreciated, the system 700 is similar to the previously discussed system 600 but has been further developed for use with predictive routers. The system 700 includes several previously discussed elements, including the personal bot 405, the customer databases 610, the other customer profiles 620, the predictor module 625, and the contact center system 200, which have been already described in detail. Thus, the present discussion will focus on describing how those elements may particularly function in relation to a routing implementation as well as introducing several new system components, which, as shown, include an interaction profile module 715, agent database 725, agent profiles 730, and a routing engine 735.

In accordance with exemplary embodiments, data driven analytics, such as machine learning, may be applied to particular datasets—for example, those described above in relation to the personalized customer profile 330 and the customer databases 610—in order to improve automated routing of incoming customer interactions. It should be understood that, unless otherwise specified, the routing systems of the present invention may be implemented with the same types of customer data presented above in relation to the customer profile 330, for example, personal data, interaction data, feedback data, and/or choice data. As will be seen, such aggregated and rich data sources may enable more accurate and reliable routing models and produce decisions that are personalized per individual customers.

As described in detail above, such data may be collected through the implementation of a personal bot 405 running on a customer device. According to exemplary embodiments, the personal bot 405 may gather information as the customer interacts with different contact centers, and newly acquired data may be used to dynamically update customer profiles 330 and customer databases 610 in real time.

The predictive routers of the present invention also may use the above-described interaction predictors to further personalize routing decisions. That is, the automated routing systems of the present invention may be enabled by a customer profile 330 having one or more interaction predictors. When utilized in the context of the interaction routing, interaction predictors may represent data driven insights about how contextual factors related to an incoming interaction affect a given customer's preferences in regard to selecting an agent. According to certain embodiments, for example, the interaction predictors may provide a score or rating that indicates how much each contextual factor of the incoming interaction affects a customer's agent preferences. As described more fully above, interaction predictors may be identified via the predictor module 625 monitoring a dataset associated with a customer profile 330 of a particular customer and customer databases 610 (which, at least in part, may include date derived from other customer profiles 620) for predictive correlations or data patterns. When gleamed from one of the customer databases 610, interaction predictors may be selectively applied to the particular customer based on similarities between that customer and the other customers represented in the customer database, where those similarities are shown to be predictively relevant.

Further, interaction predictors may be tailored to correspond to specific types of interactions with particular contextual factors and then selectively used during future interactions. For example, an interaction predictor may be identified from available data and then stored within a customer profile 330. The interaction predictor then may be recalled from the customer profile 330 and used in relation to an incoming interaction when it is determined to be applicable to the incoming interaction. Alternatively, interaction predictors also may be identified contemporaneously with an incoming interaction via the machine learning algorithm (or models developed therefrom) finding similarities in the contextual information around the incoming interaction and other past interactions experienced by the customer and/or other similar customers.

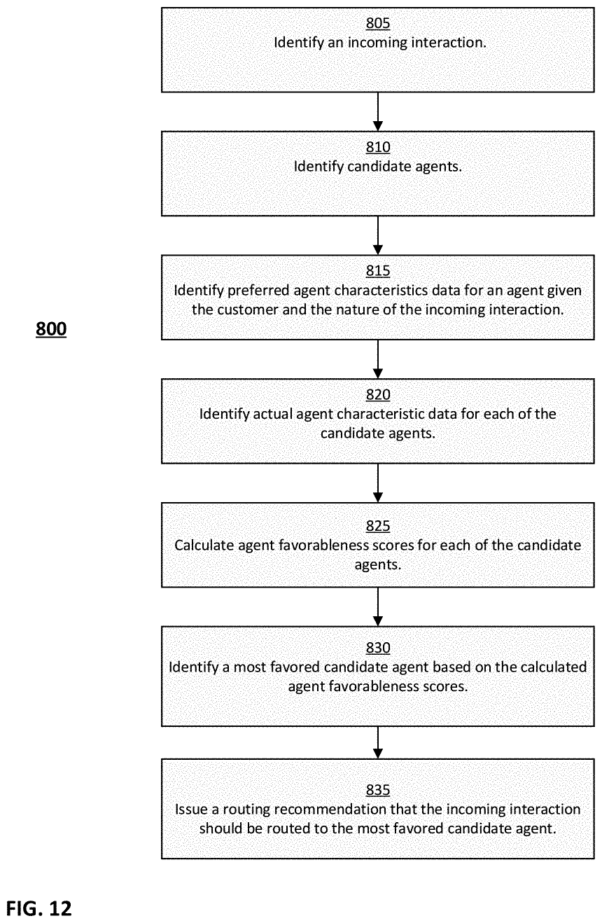

Accordingly, when used in relation to automated routing systems, an interaction predictor may relate to learned insights or knowledge about the customer that can be put to use as predictions about agent preferences, i.e., which agent the customer would rather handle an incoming interaction. To better illustrate how the present invention may be implemented in a predictive routing context, reference will now be made to both the system 700 of FIG. 11 as well as a method 800 of FIG. 12, which illustrates an exemplary routing process 800.

As indicated in the example shown in FIG. 11, the system 700 may be arranged such that the incoming interaction passes through three stages: the personal bot 405 initiates an incoming interaction and/or determines initial interaction data 765, which is transmitted (1) to the interaction profile module 715; the interaction profile module 715 then generates a personalized routing profile 770, which is transmitted (2) to a routing engine 735; and (3) the routing engine 775 generates a routing recommendation 775, which is transmitted (3) to a contact center system 200. Further aspects associated with these components are provided below.

The initial interaction data 765 may include data disclosing at least an intent of the incoming interaction and the contact center system 200 for which the interaction is intended. Using this information, the incoming interaction may be classified as being a particular type of interaction. For example, a type of interaction may be defined by a particular type of intent. This information may be used by the interaction profile module 715 to begin building the personalized interaction profile.

As used therein, the personalized routing profile is a collection of data specifically tailored to a particular interaction for a particular customer. The personalized routing profile, thus, may include specific data pertaining to the interaction and the customer that is used to facilitate the routing of interactions in accordance customer preferences. According to exemplary embodiments, the interaction profile module 715 builds the personalized routing profile according to preferred agent characteristics data for the first customer for the given type of interaction. The interaction profile module 715 may include (or at least may communicate with) the predictor module 625, which, as described above, has access to data stored in the customer profile 330 and/or the customer databases 610. The interaction profile module 715 may generate the personalized routing profiles consistent with the several embodiments discussed below.

The routing engine 735 is a logic engine that makes routing decisions based on stored algorithms, models, rules, equations or other logic. As further indicated, the routing engine 735 may be a hub that: a) receives data from the interaction profile module 715 that relates to the incoming interaction, which may be referred to generally as customer-side data or, specifically, as a personalized routing profile 770; b) receives data from the contact center system 200 that relates to the incoming interaction, which may be referred to as contact center-side data 785; and c) applies logic to the received data to calculate a routing recommendation 775. The routing engine 735 may then transmit the routing recommendation to the contact center system 200 for use in routing the incoming interaction to a particular agent.

As depicted in FIG. 11, the routing engine 735 is positioned in between the customer-side systems and the contact center system 200. This arrangement is consistent with exemplary embodiments in which the routing engine 735 is part of a customer-contact center intermediary platform (or simply “intermediary platform”) and maintained as a separate entity from both the customer-side systems, like the personal bot 405 and the interaction profile module 715, and the contact center system 200. The intermediary platform 775 may represent a neutral arbitrator for arriving at a routing recommendation that balances customer-side preferences with contact center-side business objectives. Alternatively, the routing engine 735 can be integrated into the contact center system 200 or the customer-side systems. In each of these cases, it should be appreciated that, in determining the routing recommendation, the routing engine 735 takes into the consideration customer preferences.

With specific reference now to FIG. 12, a routing method 800 is provided for selecting an agent to handle an incoming interaction based on customer preferences. As will be appreciated, the routing method 800 represents the processes that primarily occur within a routing engine, such as routing engine 735, and not the processes that occur within the interaction prediction module 715, which will be discussed below with reference to FIG. 13. The routing process 800 includes some specific terminology, which will now be defined in accordance with intended usage:
“first customer” is a reference customer in an example incoming interaction;
“incoming interaction” is a present communication (i.e., just instigated) between the first customer and a contact center;
“candidate agents” are two or more agents of the contact center that are available and/or otherwise qualified to handle the incoming interaction;
“agent criteria” are a set of agent criterion, wherein each agent criterion defines a basis by which a characteristic of an agent can be rated or evaluated;
“preferred agent characteristics data” is data describing the preferences of the first customer in relation to the agent criteria;
“actual agent characteristics data” is data describing how a particular one of the candidate agents rates in relation to the agent criteria;
“agent favorableness score” is a score reflecting the favorableness of a particular one of the candidate agents based upon how closely the actual agent characteristics data, which rates the actual characteristics of the particular agent, matches the preferred agent characteristics data of the first customer;
“evaluation of candidate agents” is an evaluation wherein an agent favorableness score is calculated for each of the available agents and, from the relative values of the calculated agent favorableness scores, a most favored candidate agent is identified;
“favored agent routing recommendation” is a routing recommendation that the incoming interaction of the first customer be routed to the most favored candidate agent.

In an example of operation, the routing process 800 may begin at step 805 where an incoming interaction is identified. The incoming interaction represents a communication between a customer and the contact center system 200 that has been initiated, but not connected. For example, the incoming interaction may be a communication just instigated by a customer (referenced for the example as a “first customer”) over any available communication channel. The incoming interaction may be identified by the interaction profile module 715 by initial interaction data 765 transmitted to it from the personal bot 405. The initial interaction data 765 may include data relating to the incoming interaction that is relevant to the building of the personalized routing profile 770. For example, the initial interaction data 765 may include data about the first customer and data about the interaction, such as the intent and other contextual factors related to the incoming interaction. Alternatively, the initial interaction data 765 may include very limited information, with additional information being retrieved by the interaction profile module 715 from connected databases, customer profiles, etc.

The routing process 800 continues at step 810 where candidate agents are identified. As used herein, candidate agents are two or more agents of the contact center that are available and/or otherwise qualified to handle the incoming interaction. In exemplary embodiments, the candidate agents may be identified by the contact center system 200 after a prompt is provided. Such prompt may be provided by the routing engine 735 upon identifying the incoming interaction (for example, upon receiving the personalized routing profile 770 from the interaction predictor module. Such prompt may include information that is necessary for the contact center system 200 to identify the candidate agents, such as, the intent of the incoming interaction.

The routing process 800 continues at step 815 where the preferred agent characteristics data for an agent is identified for the first customer. As used herein, preferred agent characteristics data is information describing the preferences of the first customer in relation to the agent criteria. As stated in the definitions above, the agent criteria are a set of agent criterion, where each criterion defines a basis by which a characteristic of an agent can be rated or evaluated. For example, an agent criterion may evaluate an aspect of an agent's personality, such as whether the agent is more playful or more serious. The preferred agent characteristics data may reflect that, for the incoming interaction, the first customer prefers a more playful agent.

In accordance with exemplary embodiments, the preferred agent characteristics data may be included within the data transmitted by the interaction profile module 715 in the personalized interaction profile. As discussed more below, the preferred agent characteristics data may be determined by the interaction profile module 715 and may include predictions as to the preferences of the first customer. With access to data relating to each of the first customer's past interactions and other activities performed via the first customer's mobile device, the customer-side systems (e.g., the personal bot 405, interaction profile module 715, and the predictor module 625) are well-positioned to make data driven inferences that provide the basis for such predictions. As will be seen, such predictions may be based on the intent of the incoming interaction and/or other contextual factors relating to the incoming interaction. For example, such predictions may be based on the applicability of one or more interaction predictors stored within the customer profile, such as those related to an emotional state of the customer or severity rating of the interaction.

The routing process 800 continues at step 820 where the actual agent characteristics data for each of the candidate agents is identified. As used herein, actual agent characteristics data is data describing how a particular candidate agent rates in relation to the agent criteria. As will be appreciated, the actual agent characteristics data for each of the agents may be stored within agent profiles 730 maintained in the agent database 725 of the contact center system 200. The actual agent characteristics data may be part of the contact center-side data 785 that is transmitted by the contact center system 200 to the routing engine 735.

The routing process 800 continues by evaluating the candidate agents. As described more below, the evaluation of the candidate agents may include two steps: a) calculating an agent favorableness score for each of the available agents (step 825); and b) identifying, from the relative values of the calculated scores, a most favored candidate agent (step 830).

Thus, at step 825, the routing process 800 proceeds by calculating agent favorableness scores for each of the candidate agents. An agent favorableness score is a score reflecting the favorableness of particular one of the candidate agents based upon how closely the actual agent characteristics data, which describes the actual characteristics of the particular agent, matches the preferred agent characteristics data of the first customer. As will be appreciated, this may be accomplished using a variety of different scoring systems and algorithms. In general, the candidate agents will be scored via the agent criteria, with the score for each being indicative of how closely the actual agent characteristics data satisfies the preferred agent characteristics data of the first customer. For example, the agent favorableness score may be a cumulative score that reflects how well a particular agent scores in regard to all of the agent criteria. As another example, the scoring system may be a weighted one that places greater importance to certain agent criterion over others. In such cases, the weights applied to each category may be the same for all customers. Alternatively, the way the weights are applied could be varied between customers and, thus, be used as another mechanism to express different customer preferences.

At step 830, as stated above, the routing process 800 proceeds by identifying a most favored candidate agent based on the calculated agent favorableness scores. As will be appreciated, this step may be performed by comparing the relative values of the calculated agent favorableness scores and determining which is the best and, thus, reflective of a most favored agent given the first customer's preferences.

The routing process 800 then continues at step 835 where a routing recommendation is issued. As will be appreciated, the routing recommendation may be that the incoming interaction is routed to the most favored candidate agent. As shown in FIG. 11, this step may include the routing engine 735 transmitting the routing recommendation 775 to the contact center system 200.

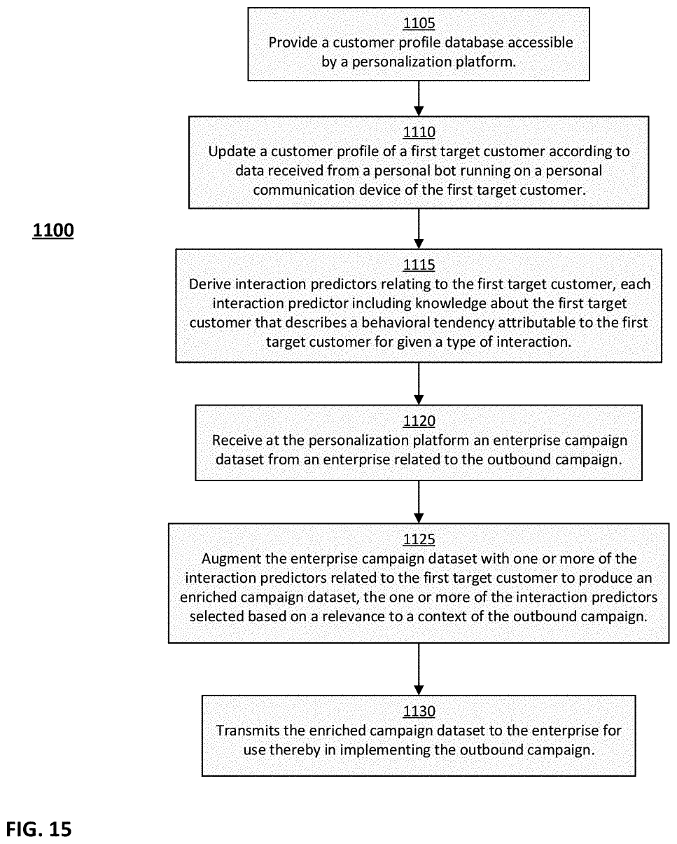

With continued reference to routing processes and concepts introduced above in relation to FIGS. 14 and 15, attention will turn to several routing examples, which, in accordance with the present invention, are personalized pursuant to interaction predictors, contextual factors, and other data stored within a customer profile 330. These examples will reference example customers “Jane” and “Betty”. It should be appreciated that these examples have been simplified so to clearly illustrates intended functionality.

A first example involves a case where the routing decision is personalized, at least in part, pursuant to personal data maintained in the customer profiles 330. Jane is a business class passenger with Delta. Jane initiates an interaction with Delta and is connected to speak with “Agent Dave”. Jane has initiated the interaction via using a mobile application on her smart phone, which includes the above-described personal bot 405. The topic of the interaction is Jane's frequent flyer miles, which Jane has noticed were wrongly updated in her account. From Jane's perspective, the conversation she has with Agent Dave goes exceedingly well. Agent Dave rates as having average proficiency in terms of being knowledgeable and efficient in handling customer issues, but is rated as being funny, playful, and easy to talk with. The conversation goes so well that Jane completely forgets about the original mistake that prompted her to make the call and, indeed, is receptive to making an additional (upsell) purchase that was suggested by Agent Dave. Specifically, after noting how well the conversation had progressed, Agent Dave points out that if Jane purchases more frequent flyer miles during an ongoing Delta promotion, she would receive a free companion ticket and be promoted to a higher level in the Delta's frequent flyer program. All the information related to this interaction is gathered by the personal bot 405 and stored with Jane's customer profile. The information may also be anonymously used in the customer databases 610.

A new interaction is later initiated by a different customer “Betty”, who is also a business class passenger, but for United. Betty is calling for a similar reason as Jane related to a discrepancy with her frequent flyer miles.

Betty's customer profile has limited interaction data that is relevant to the intent of this incoming interaction. However, the predictive module has found sufficient similarities between the personal data of Betty and that the personal data of a group of other customers within the customer database, which includes Jane, that previous routing successes associated with those customers are determined as likely being instructive in how to route Betty's incoming interaction.

Thus, for example, aspects of Jane's previous interaction may be used to create an interaction predictor that is implemented within Betty's customer profile and used to facilitate a routing decision in Betty's incoming interaction. The interaction predictor, for example, may predict that Betty should be routed to an agent who is similar to Agent Dave of Delta (i.e., funny, playful, etc.). An additional interaction predictor may be applied in which the upselling opportunity for Betty's incoming interaction is predicted. For example, generally, when a customer is calling about an issue, the upselling opportunity may be deemed as poor. However, in relation to this interaction, the interaction predictor for upselling may be rate the opportunity as better than would be generally anticipated based, at least in part, on the successful upsell that occurred in Jane's previous interaction with Agent Dave. With such interaction predictors gleamed from specific customer profiles and included within a personalized routing profile, the routing engine would score some agents better than others and, thereby, arrive at a routing recommendation that is likely to improve the overall experience for Betty as well as the potential business outcome for the airline.

A second example involves a case where the routing decision is personalized, at least in part, pursuant to interaction data maintained in the customer profiles 330. As previously described, with all the past interactions between different customers and various enterprises, the personal bot 405 and/or predictor module 625 of the present invention could mine the customer databases 610 to determined predictive correlations that are instructive as to a customer's present expectations and needs. With this “learned” knowledge, a level of service could then be delivered that is anticipated to satisfy the expectations of a customer related to an incoming interaction. Also, such knowledge could provide customer service providers with the ability to reach out to customers and fill expectations or needs proactively.

For example, consider another example involving Jane and Betty. Jane has an interaction with Delta, wherein it is learned that she is travelling to Barcelona. Jane also has an interaction with a hotel in Barcelona, which is a Marriott, in which she books a room. The data from these past interactions may be monitored and recorded by the personal bot 405 and saved within Jane's customer profile. Such interaction data may be mined by the personal bot 405 and added to the general customer database 610 and/or implemented as an interaction predictor within Betty's customer profile based, as in the example above, on similarities between Betty and Jane/other similar customers within the customer database.

Now, when Betty initiates an incoming interaction, and it is determined that, like Jane, Betty is a business class traveler who is travelling to Barcelona and looking to book a hotel, several interaction predictors may be used to personalize the routing. For example, an interaction predictor may be used to recommend an agent type for Betty based on an agent that was successful in handling Jane's booking. As another example, an interaction predictor may be used to recommend an agent type who is knowledgeable in a range of hotels that includes ones similar to the Marriott that Jane booked. Further, given the knowledge acquired about Betty's intent, Marriott and/or hotels similar to Marriott may be allowed to reach out to Betty proactively, for example, to inform her about upcoming booking deals in Barcelona.

A third example involves a case where the routing decision is personalized, at least in part, pursuant to feedback data maintained in the customer profiles 330. As previously described, the personal bot 405 of the present invention may collect feedback and survey details whenever provided by customers. The personal bot can understand if a customer is satisfied with a resolution provided by an agent not only by a customer satisfaction score, but also through data driven models trained to automatically infer such feedback from the statements made by the customer at the end of the interaction. Such feedback provides valuable data on whether the agent works well with this type of customer profile 330, which can be mined so that better routing decision can be achieved for further interaction involving similar customers, similar contexts, and/or similar agents.

For example, consider another example involving Jane and Betty. Jane has spoken with Delta about a family emergency requiring her to cancel a flight that she had booked already. To do this, Jane is again connected with a funny and playful agent, like Agent Dave, who takes too long to get to the point and is too playful given Jane's present agitated and worried mood. For this particular interaction given the contextual factors, the choice of agents has led to a frustrating experience for Jane. Jane later provides feedback as to this experience, which is added to Jane's customer profile. As before, the feedback may be mined by the personal bot 405 and added to general customer database and/or implemented as an interaction predictor within Betty's customer profile based, as in the examples above, on similarities between Betty and Jane as well as other similar customers.

Later a new interaction is instigated by Betty, who is calling for a similar reason as Jane involving a change in travel plans due to a family emergency. In a manner similar to the other examples, the predictive correlations gleamed from Jane and other customers may be applied to Betty based on similarities found to predictive between Betty and Jane/other customers. Thus, at least in part, useful feedback provided by Jane may be used in determining a routing recommendation for Betty. One or more interaction predictors may be implemented in the routing of Betty's incoming interaction that, for example, recommend a greater likelihood of success with a routing to an agent who is more serious, understanding, and direct or “to the point”.

A fourth example involves a case where the routing decision is personalized, at least in part, pursuant to “choice data” maintained in the customer profiles 330. Generally, when dealing with a contact center, customers do not have the ability to choose an agent or type of agent for their interaction. For example, customers are not allowed to review a group of agent profiles and select the one that seems most appealing. As will be appreciated, if this were allowed, the choice data reflecting the choices made by a customer would provide valuable insight as to the type of agents a customer prefers. Such insights could be applied to other customers based on similarities found predictively relevant.

In accordance with embodiments of the present invention, the personal bot 405 can provide agent summary profiles to a customer and allow the customer to select. The agent summary profiles may include certain information gleaned from the agent profiles 730 maintained at the contact center system 200, which may be transmitted to the personal bot 405 upon request. For example, an agent summary profile may include a picture of the agent and a short description of the agent's personality.

Initially, the choice data acquired from a customer's choices may provide a greater level of understanding as to particular preferences in an agent. As time goes by, though, predictions in regard to a particular customer may be made even when contextual factors to an interaction are new, for example, a new intent or when dealing with a new enterprise. Further, choice data for one customer may be used to make predictions about other customer base on similarities therebetween. Specifically, the predictions based on the choice data of a group of customers may be found applicable to another customer based on similarities found between the group and the other customer. As such customer choice data is obtained and updated in customer profiles 330, it may provide the basis for determining interaction predictors, which ultimately may be used within the personalize routing profiles to calculate agent favorableness ratings and influence subsequent routing decisions.

For example, if Jane constantly chooses to speak with a funny or entertaining agent for retail queries, the accumulated choice data can be used to influence not only the routing of Jane's future interactions, but also the routing of similar interactions of similar customers, such as Betty.

As will be appreciated, the present invention may include many different kinds of interaction predictors, which are applicable to specific interactions and contexts and helpful in personalizing routing decisions for individual customers. These interaction predictors include those that were just discussed in relation to the “Jane” and “Betty” examples but may also include those discussed above in the “Adam” examples of FIG. 9 that introduced personalized customer profiles. As will be recalled, that discussion provided details relating to interaction predictors involving emotional state, severity rating, and upselling/cross-selling opportunity. These will be touched on again in the context of predictive routing.

By analyzing the pattern of the interactions made by the customer across different contact centers, the systems of the present invention may be able to predict an emotional state of a customer coming into an incoming interaction and/or a severity rating for an interaction. For example, in an accident situation, a customer may have placed several previous calls to emergency services and insurance providers. Using the systems and methods already described, these previous interactions may be recognized by the personal bot 405 and used to predict an emotional state for the customer. Further, the personal bot 405 may be able to predict a severity rating for the interaction (i.e., how important the interaction is to the customer). As will be appreciated, in this case the severity rating would be predicted as being high or very severe. In either case, one or more interaction predictors could provide these predictions to a routing engine for use in the routing of the next interaction instigated by the customer. For example, in this case, the one or more interaction predictors used in building a personalized interaction profile may recommend that incoming interaction be routed to an agent who is serious, understanding, and adept at handling emotional customers.

In similar fashion, other interaction predictors can be used to provide contextual insights that produce better routing decisions. For example, interaction predictors may be configured to provide insights as to upselling or cross-selling opportunities. In this case, if the systems and methods described herein predict that the upselling or cross-selling opportunity of an incoming interaction is good, the interaction may be steered toward agents that are skilled in this area.

With reference now to FIG. 13, a method 900 is shown for personalizing the routing of an interaction initiated by a particular customer, which, again, will be referenced as a “first customer”. In accordance with exemplary embodiments, the method 900 facilitates such routing in accordance with customer preferences. In presenting this aspect of the present invention, continued reference is made to FIGS. 13 and 15, as the method 900 draws on several of the ideas and concepts introduced above in relation to the methods 650 and 800, respectively. Further, continued reference is made to FIG. 11, which includes exemplary systems and components for performing the steps of methods, such as the one shown in FIG. 13.

The method 900 may begin at step 905 by receiving initial data identifying an incoming interaction initiated by the first customer. According to exemplary embodiments, the initial interaction data 765 may include data disclosing at least an intent of the incoming interaction and the contact center system 200 for which the interaction is intended. Using this information, the incoming interaction may be classified as being a particular type of interaction, which is referred to generally herein as a given type of interaction or interaction type. For example, a type of interaction may be defined by a particular type of intent. In regard to the exemplary system 700 of FIG. 11, the initial interaction data 765 may be sent by the personal bot 405 and received by the interaction profile module 715.

At a next step 910, the method 900 proceeds by generating a personalized routing profile that includes preferred agent characteristics data for the first customer for the given type of interaction. As described, this step may be performed by the interaction profile module 715, which includes (or at least communicates with) a predictor module 625 in communication with or having access to data stored in the customer profile 330 and/or the customer databases 610. According to exemplary embodiments, the performance of step 910 may include several actions, which are indicated in FIG. 13 as the broken-out subprocess of steps 911-914. This subprocess—which will be referred to as a “first process” and discussed more below—may include the following steps. At a step 911, the first process beings by identifying a dataset that includes interaction data from the customer profile of the first customer. At a step 912, the first process includes applying a machine learning algorithm across the dataset to identify patterns correlating actual agent characteristics to a desired outcome for the given type of interaction. At a step 913, the first process includes basing the preferred agent characteristics data for the incoming interaction on the actual agent characteristics data found to correlate to the desired outcome. And, at a step 914, the first process concludes by generating the personalized routing profile so to include the preferred agent characteristics data of the first customer.

Once the first process is performed, the method 900 proceeds to a step 915, which, as shown in FIG. 11, includes transmitting the personalized routing profile 770 to a routing engine 735. From there, the method 900 proceeds to a step 920, where a routing recommendation for the incoming interaction is derived based, at least in part, on the preferred agent characteristics data of the first customer. Finally, as also shown in FIG. 11, at a step 925, the method 900 concludes by transmitting the routing recommendation 775 to a contact center system 200 for use in routing the incoming interaction.

The method 900 may be performed in accordance with several additional or alternative steps, which, as will now be discussed, provide a range of functionality. Further, as with the method 650 of FIG. 10, the terminology used in describing the method 900 may be defined in accordance with several alternative uses to cover a range of different applications, as provided in the following examples.

As already described, the first process is the process by which the personalized routing profile is generated. According to exemplary embodiments, the personalized routing profile is a profile specifically tailored to a particular interaction for a particular customer. The personalized routing profile, thus, may include specific data pertaining to the interaction and the customer that may be used to facilitate the routing of interactions in accordance with one or more preferences of the first customer. With this in mind, the first process may generally include the steps of: a) accessing data from a database that includes at least a first customer profile storing data relating to the first customer; b) based on the accessed data and the intent of the first incoming interaction, determining preferred agent characteristics data of the first customer for the first incoming interaction; and c) generating the personalized routing profile so to include the preferred agent characteristics data of the first customer. Within this general methodology, several other specific embodiments of the first process will now be described.

As a first embodiment, the data used by the first process includes interaction data relating to past interactions that occurred between the first customer and a plurality of the contact centers. With this embodiment, the first process includes the steps of: a) identifying, from the past interactions of the first customer, qualifying examples in which an intent matches the intent of the first incoming interaction, and a desired outcome is achieved; b) determining one or more consistencies across the actual agent characteristics data of the agents in the qualifying examples of the past interactions; and c) basing the preferred agent characteristics data for the first incoming interaction on the one or more consistencies across the actual agent characteristics data.

As a second embodiment, the data used by the first process again includes interaction data relating to past interactions that occurred between the first customer and a plurality of the contact centers. With this embodiment, the first process include the steps of: a) applying a machine learning algorithm across the interaction data from the past interactions to identify patterns correlating one or more factors to a desired outcome for a given type of interaction, wherein, in performing this step: the one or more factors may be defined as the actual agent characteristics data of the agents in the past interactions; the desired outcome may be defined as ones of the past interactions receiving positive customer feedback or achieving a successful resolution; the type of interaction is defined as an interaction having an intent that matches the intent of the first incoming interaction; and b) basing the preferred agent characteristics data for the first incoming interaction on the actual agent characteristics data found to correlate to the desired outcome. As with other embodiments, the machine learning algorithm may include a neural network.

A third embodiment may include the first customer and a plurality of other customers (or “other customers”). The data used by the first process may further include one or more customer databases that include interaction data relating to past interactions that occurred between the other customers and a plurality of the contact centers. With this embodiment, the first process includes the steps of: a) identifying, from the past interactions of the other customers, qualifying examples in which an intent matches the intent of the first incoming interaction; a desired outcome is achieved; and a predetermined similarity is found to exist between the first customer and a particular one of the other customers involved in the past interaction; b) determining one or more consistencies across the actual agent characteristics data of the agents in the qualifying examples of the past interactions; and c) basing the preferred agent characteristics data for the first incoming interaction on the one or more consistencies across the actual agent characteristics data.

In a fourth embodiment, the first process may again use data derived from one or more customer databases that include interaction data relating to past interactions that occurred between the other customers and a plurality of the contact centers. With this embodiment, the first process includes the steps of: a) applying a machine learning algorithm across the interaction data from the past interactions to identify patterns correlating one or more factors to a desired outcome relevant to a type of customer given the type of interaction, wherein, in performing this step: the one or more factors is defined as the actual agent characteristics data of the agents in the past interactions; the desired outcome is defined as ones of the past interactions receiving positive customer feedback or achieving a successful resolution; the type of interaction is defined as an interaction having an intent that matches the intent of the first incoming interaction; and the type of customer is defined as one that shares one or more common characteristics with the first customer; and b) basing the preferred agent characteristics data for the first incoming interaction on the actual agent characteristics data found to correlate to the desired outcome. In addition, the customer profile and the one or more customer databases may store biographical personal data relating to the first customer and the other customers, respectively. The one or more common characteristics may include one or more characteristics stored within the biographical personal data.

In a fifth embodiment, the interaction data of the other customers may include feedback data, with the feedback data including an evaluation provided by a particular one of the other customers in relation to a particular one of the past interactions. With this embodiment, the first process includes the steps of: a) applying a machine learning algorithm across the interaction data from the past interactions to identify patterns correlating one or more factors to a desired outcome relevant to a type of customer given a type of interaction, wherein, in performing this step: the one or more factors is defined as the actual agent characteristics data of the agents in the past interactions; the desired outcome is defined as ones of the past interactions wherein the feedback data is classified as being positive; the type of interaction is defined as an interaction having an intent that matches the intent of the first incoming interaction; and the type of customer is defined by a shared similarity with the first customer; and b) basing the preferred agent characteristics data for the first incoming interaction on the actual agent characteristics data found to correlate to the desired outcome. The feedback data may include feedback inferred from one or more statements made by the other customers within a concluding portion of the past interactions, which is also discussed above as conclusory statement data.

In a sixth embodiment, the interaction data of the other customers may include choice data, with the choice data including data relating to selections the other customers make when allowed to select an agent (or “selected agent”) from a plurality of offered agents. With this embodiment, the first process includes the steps of: a) applying a machine learning algorithm across the interaction data from the past interactions to identify patterns correlating one or more factors to a desired outcome relevant to a type of customer given a type of interaction, wherein, in performing this step: the one or more factors is defined as the actual agent characteristics data of the selected agents; the desired outcome is defined as ones of the past interactions receiving positive customer feedback or achieving a successful resolution; the type of interaction is defined as an interaction having an intent that matches the intent of the first incoming interaction; and the type of customer is defined as one that shares a predetermined similarity with the first customer; and b) basing the preferred agent characteristics data for the first incoming interaction on the actual agent characteristics data found to correlate to the desired outcome.

In a seventh embodiment, the first process may include the steps of: determining one or more contextual factors relating to the incoming interaction by finding relationships between the initial data and data stored within the customer profile of the first customer; and based on the one or more contextual factors, determining an interaction predictor, the interaction predictor comprising a prediction applicable to the first customer for the incoming interaction. In this case, the determination of the preferred agent characteristics data of the first customer for the first incoming interaction is also based on the interaction predictor. The interaction predictor may include a predicted upselling/cross-selling opportunity rating. The predicted upselling/cross-selling opportunity rating is defined as a receptiveness of the first customer to considering offers made by the agent in relation to upselling or cross-selling during the first incoming interaction. Alternatively, the interaction predictor may include a severity rating. The severity rating predicting a level of importance that the first customer ascribes to the first incoming interaction. As another alternative, the interaction predictor may include a predicted emotional state. In this case, for example, the one or more contextual factors may include a minimum number (e.g., at least two) of the past interactions of the first customer being instigated by the first customer within a predetermined lookback period (e.g., less than 6 hours). The predetermined lookback period may be measured from when the first customer instigates the first incoming interaction. The past interactions instigated by the first customer within the predetermined lookback each may include: a subject matter that matches a subject matter of the first incoming interaction; and an unsuccessful attempt at resolving a customer problem relating to the subject matter. In such cases, the predicted emotional state may include a negative emotional state.

Though not necessary to practice aspects of the present invention, certain embodiments include the performance of additional or downstream steps whereby the personalized routing profile, as generated by the first process, is utilized in some way. Several of these alternatives will now be presented in which these downstream steps will be reference as a “second process”.

For example, the present invention may include a second process that simply includes deriving the routing recommendation based on the preferred agent characteristics data of the first customer. As an alternative, the personalized routing profile may be transmitting the to a routing engine for use in deriving a routing recommendation for the first incoming interaction. In another example, the second process includes the steps of: a) deriving the routing recommendation for the first incoming interaction based on the preferred agent characteristics data of the first customer; and b) transmitting the routing recommendation to a contact center for routing the first incoming interaction in accordance therewith.

Another exemplary embodiment includes a second process that generates a routing recommendation based on the personalized routing profile. In this case, the second process may include the steps of: receiving data identifying candidate agents, the candidate agents comprising at least two of the agents of the first contact center that qualify for handling the incoming interaction; receiving actual agent characteristics data for each of the candidate agents; calculating an agent favorableness score for each of the candidate agents, the agent favorableness score comprising a mathematical representation indicative of how closely a match is between the actual agent characteristics data for a particular one of the candidate agents and the preferred agent characteristics data of the first customer; identifying a most favored candidate agent as a one of the candidate agents producing the agent favorable score indicating a closest match between the actual agent characteristics data and the preferred agent characteristics data; and generating a routing recommendation that recommends routing the first incoming interaction to the most favored candidate agent. The second process may further include the step of causing the first incoming interaction to be routed in accordance with the routing recommendation. Alternatively, the second process may further include the step of transmitting the routing recommendation to the first contact center for use thereby in routing the first incoming interaction.

In other exemplary embodiments, the second process includes receiving information from the contact center to generate the routing recommendation. For example, in this case, the second process may include the steps of: a) receiving contact center-side data from the first contact center relating to the first incoming interaction, the contact center-side data disclosing at least: candidate agents, the candidate agents comprising at least two of the agents of the first contact center that qualify for handling the incoming interaction; actual agent characteristics data for each of the candidate agents; and preferred agent characteristics data of the first contact center, the preferred agent characteristics data comprising data that describes preferences of the first contact center in relation to the agent criteria based on a contact center performance objective; b) generating combined preferred agent characteristics data by combining via a weighted average the preferred agent characteristics data of the first customer and the preferred agent characteristics data of the first contact center; c) calculating an agent favorableness score for each of the candidate agents, the agent favorableness score comprising a mathematical representation indicative of how closely a match is between the actual agent characteristics data for a particular one of the candidate agents and the combined preferred agent characteristics data; d) identifying a most favored candidate agent as a one of the candidate agents producing the agent favorable score indicating a closest match between the actual agent characteristics data and the combined preferred agent characteristics data; e) generating the routing recommendation that recommends routing the first incoming interaction to the most favored candidate agent; and f) transmitting the routing recommendation to the first contact center.

### Personalization Platform

With reference now to FIGS. 14 and 15, aspects of the present invention also may be used to implement what will be referred to herein as a “personalization platform”, which, as will be seen, may include an intermediary between enterprises and customers that enables customer personalization and other services, particular in relation to implementation of outbound campaigns. It will be appreciated that aspects of the personalization platform and related functionality draw upon functionality already described in the systems and methods above. For example, unless stated otherwise, the personal bot, customer profile, customer databases, and related network components may function in the same or similar manners relative to the personalization platform as already provided. Further, aspects of the personalization platform may function in ways similar to the that described in relation to the interaction profile module and predictor module. For brevity's sake, description of functionality already described will be limited.

As will be appreciated, enterprises and other organization (referred to herein generally “enterprises”) regularly conduct outbound campaigns in which information, advertisements, marketing materials, and/or offers (referred to herein generally as “offers”) are disseminated to prospective customers. Such campaigns play an important role in enterprises finding new customers, increasing sales, and improving trust levels with customers. The evolution of these campaigns advanced from randomized to predictive dialing. With predictive dialing, limited customer intelligence is used to contact a more targeted set of customers. Of course, there are some significant flaws with the current approach. For example, being generally inundated with offers, customer begin to treat all offers of outbound campaigns like spam. Customers have become to expect a more personalized approach and are turned away by what still seems to be a blanket approach of most predictive dialing campaigns. Customers would prefer receiving more appealing and specialized content but, instead, their inboxes are overloaded with spam-like offers, the number of which is only increasing given the proliferation of enterprises and consumer products.

On the other hand, in conducting outbound campaigns, enterprises would prefer to reach out to customers in more personalized and interesting ways but to lack the capabilities to effectively do this. That is, most of the time, enterprises are working with limited information when considering which customers to target. Further, when reaching out to the customers, enterprises often are wrong as to when they should do this and by what channel should they be making their approach. Enterprises just do not have the complete customer information and other data needed to design personalized offers and present those offers in appealing ways. As will be seen, with more complete customer information, a personalized offer could include customized content, customer specific pricing, and/or suggestions provided to an agent during an interaction covering ways to approach a given customer and useful negotiation tactics. Instead outbound campaigns are increasingly relying on “blanket approach” automation that turns away customers and makes them feel like spam targets. This, of course, leads to a situation where outbound campaigns are not only unproductive for enterprises but result in customers missing out on offers they otherwise would be interested in pursuing.

Given this backdrop, the present application proposes systems and methods for enhancing the personalization of outbound campaigns. As will be seen, such systems and methods may include different kinds of functionality implemented by a customer-oriented personal digital assistant or “personal bot” and a personalization platform. As already described herein, the personal bot may include a mobile application residing in a customer's personal device. The personal bot will have the capability of assisting customers in communicating and connecting with many different types of enterprises. In regard to the personalization platform, it will serve as an intermediary of sorts between customers and the enterprises, for example acting as an intelligent endpoint on behalf of the customer and an intelligent advisor for enterprises in conducting outbound campaigns. In this way, the personalization platform may function as a trusted “middleman” between a customer's personal bot and an enterprise's outbound campaign. As provided above, the personalization platform may have access to and use the data within customer profiles that, at least in part, are created, updated, and maintained by personal bots. The personalization platform may use insights gained from that data to assist enterprises in making personalized offers that, for example, are aimed at the right customers, included tailored content, and are made at the right time via the right channel. The following sections will discuss in more detail how this accomplished, with the section immediately following focused on how the personalization platform and personal bots serve enterprises in planning and executing outbound campaigns and other marketing activities. The section after that looks more closely at how the personalization platform and personal bots serve customers. It should be appreciated that, while advantages and use cases are discussed below separately in regard to enterprises and then customers, the functionality of the personalization platform and personal bots may mutually beneficial to customers and enterprises.

### Personalization Platform for Assisting Enterprises

With specific reference to FIG. 14, a system 1000 is shown that includes a personalization platform 1005 in accordance the present invention. As illustrated, the outbound campaign server 1010 of an enterprise may connect with the personalization platform 1005 to utilize the customer information and predictions or insights (referred to herein generally as “interaction predictors” or simply “predictors”) derived and maintained therein so to personalize offers made via an outbound campaign.

According to exemplary embodiments, the outbound campaign server 1010 of an enterprise may send a dataset to the personalization platform 1005 relating to an upcoming outbound campaign. This dataset may be referred to herein as an “enterprise campaign dataset” 1020. The personalization platform 1005 may then enrich or augment the enterprise campaign dataset 1020 with personalized campaign data, which, once enriched, is a dataset that may be referred to herein as an “enriched campaign dataset” 1030. In general, the enriched campaign dataset 1030 includes favored customers to target and a predicted success rate, a favored way and content for reaching those customers, and tailored content and pricing suggestions. The personalization platform 1005 may supply the enriched campaign dataset 1030 from predictions made in accordance with the interplay between data describing the campaign, as included in the enterprise campaign dataset 1020, and insights or predictors applicable to a targeted group of customers that are maintained at the personalization platform 1005 and derived from saved customer profiles. As already described, such customer profiles may be updated and maintained pursuant to operation of the personal bots 405, and the predictors derived via operation of a predictor module 625 that is part of the personalization platform 1005. The enterprise campaign dataset 1020, for example, may include data describing the campaign subject matter or context, a list of prospective customers (along with any data the enterprise or contact center may have on each of the prospective customers, such as data on past interactions and general profile), and available agent data, such as, for example, data related to agent profiles for those agents that are anticipated as being available during campaign implementation. In accordance with exemplary embodiments, if the enterprise is able to provide detailed agent profiles, agent specific customer segmentation and/or best agent/customer match may be provided in the enriched campaign dataset 1030. However, even if agent profiles are not provided by the enterprise, the personalization platform 1005 may still schedule customer and agent pairings based on more general agent classifications. In either case, personalization on the level of which agent or agent tied is the best fit for a particular customer interaction can be accurately provided as part of the enriched campaign dataset 1030, which, as will be seen, can then be used to provide effective agent scheduling and workforce optimization during the campaign.

More specifically, in accordance with the present invention, an enterprise may use the personalization platform 1005 for conducting an outbound campaign in the following ways. First, an enterprise decides to initiate an outbound campaign and makes a request to the personalization platform 1005 for assistance in implementing the outbound campaign. As part of this request, the enterprise transmits and enterprise campaign dataset 1020. As mentioned, the enterprise campaign dataset 1020 may include several types of information about the outbound campaign that is then used by the personalization platform 1005 to create an enriched campaign dataset 1030. The data included within the enterprise campaign dataset 1020 includes data describing the nature or subject matter or context of the outbound campaign. This type of information may include the type of products and services being offered in the campaign as well as the timing of the campaign and pricing information. The enterprise campaign dataset 1020 may further include a list of customers as well as known contact information for those customers related to those customers, such as interaction history or profile data. The list of customers, for example, may be as broad or targeted as the enterprise desires, but as part of the process, the personalization platform 1005 may selectively pare down the list of prospective customers that is provided by the enterprise and/or had customers to the list. The enterprise campaign dataset 1020 may further include a list of agents that will be available during the campaign as well as any available agent profile data, such as performance history, skills or specialization, and personality data.

Once this packet of information is received, the personalization platform 1005 uses the available data, intelligence, and predictors derived from the customer profiles to make associations and predictions deemed to have predictive relevance to aspects of the upcoming campaign. In this way the personalization platform 1005 enriches the data received from the enterprise. This enriched packet of information is then provided to the enterprise as necessary for the conduct of the campaign. In accordance with exemplary embodiments, the personalization platform 1005 may use machine learning or deep neural network models to mine the insights and predictors from stored customer profiles that are used to create enriched campaign dataset 1030. This process may include the methods and systems already discussed herein as well as the following.

In accordance with exemplary embodiments, for example, using the received list of customers and given context of the campaign, the personalization platform 1005 makes predictions about the identified customers. The predictions may be based on analysis of direct data available for a given customer (i.e., data relating to actions taken by that that particular customer or characteristics known to be attributable to that particular customer). The predictions or predictors also may be based on the attributable data, which is data relating to other customers—for example, customers represented in the stored customer profiles—and deemed attributable to another customer due to similarities found to be predictively relevant. Such predictions also may be correlated in accordance with prior campaigns, particular in regard to similarity of context and type of enterprise. So, for each of the customers identified in the customer list within the enterprise campaign dataset 1020, the personalization platform 1005 may derive a set of predictors, such as values, behaviors, preferences, and/or characteristics, that are found to be productive in personalizing outbound campaigns for greater success.

For example, the personalization platform 1005 may provide predictors relating to a favored time and channel for reaching each of the customers. As stated, such predictors may come from direct data regarding a particular customer's past interactions. Or, such predictors could be derived from analyzing the past interactions of similar customers. That is, the personalization platform 1005 may predict a favored time and channel for a reaching given customer by looking at past successes with similar customers. For example, there may be little direct data available for a particular customer—hereafter “first customer”— but this customer may be found to be associated with one or more known customers—which may be referred to as “associated customers”—due to several shared characteristics. As an example, such associated customers may be known to possess several common or similar characteristics, such as age, sex, profession, and those common characteristics determined to be predictively relevant in relation to certain other behaviors or preferences. When the first customer is found to also possess those several characteristics, this association may then be used to predict other characteristics that are significant to the outbound campaign. Thus, when the associated customers are found to be more reachable by phone during a certain time period in the day, the personalization platform 1005 may use this to predict that the favored time to contact the first customer constitutes a similar time period. The same process may be used to predict other aspects, such as favored channel, favored content, etc.

In accordance with example embodiments—and continuing with the reference to the “first customer”—a prediction may be made as to what type of agent should be used to contact the first customer to increase the chance of success. Any available profile data associated with the first customer, specifically information associated with past interactions, may be analyzed to do this. However, if this is not available, data associated with the past interactions of associated customers may be used in this analysis to predict an agent type that will yield the highest likelihood of a successful interaction. If the personalization platform 1005 is not provided with the profiles for the available agent, then a predictor concerning a favored agent type may be provided to the enterprise, which then may be used by the enterprise to match agent to customer. As will be appreciated, this type of information may be used by a contact center to improve the scheduling of the agents. For example, if an outbound campaign is scheduled for a particular day, this favored agent intelligence may be used with a workforce management tool to schedule agents according to how those agent match to customer preferences as well as the favored times predicted for reaching those customers. Thus, agents may be scheduled to overlap as much as possible with the favored times for contacting those customers with which they best match.

Thus, in accordance with example embodiments, the customer list of an outbound campaign may be segregated based on the received agent profiles and agent characteristics described therein. In this way each agent provided in the enterprise campaign dataset 1020 may be matched to a list of best suited customers. In addition, the data provided in the enriched campaign dataset 1030 may include insights, predictors, and characteristics of those matched customers that assist the agent to handle the interaction successfully.

In accordance with example embodiments, the personalization platform 1005 may predict a “patience score” for each of the customers, which, in general, relates to a customer's tendency to remain patience while waiting to be connected with an agent. The patience score may be based on the context of the interaction, direct data of past interactions, and by analyzing the profiles and past interactions of associated customer.

In accordance with example embodiments, the personalization platform 1005 may predict a “success probability score” that indicates a probability as to the success of an outbound call in relation to a particular customer. Such a score may be based on assumptions, such as, if the call is place at the prescribed favored time via the prescribed favored channel for that particular customer. This value, for example, can be used as a consideration in scoring agent performance. Further, a “next favored time” may be selected when there is a failure to connect with a particular customer at that customer's prescribed favored time, where the next favored time is determined in relation to a calculated success probability.

In accordance with example embodiments, the personalization platform 1005 may provide additional predictors or insights via the same processes. These may include customer specific pricing, upselling and cross selling opportunities, how long the call should last for particular customers, personalized content that should be used, and types of advertisements that should be played. These additional predictors will be covered more below as part of the discussion related to agent specific, channel specific and campaign specific enrichments.

Using deep learning and neural networks, the personalization platform 1005 will be able to efficiently predict handle times for interactions with particular customers, which may be used to more efficiently schedule agent workforce and calls. This type of information can be used to effectively calculate and limit wait times in regard to next customers for each of the agents. For example, if a first agent is predicted to have a handle time related to a first customer of 100 seconds, and a second customer that is scheduled to talk to the first agent next but has a patience score that predicts the second customer only tolerates a wait time of around 10 seconds, this type of predictor can be used by the outbound campaign server 1010 to schedule the call to the second customers at 90 seconds into the call with the first customer. In this and in other ways, agent specific intelligence derived by the personalization platform 1005 may improve outbound campaigns in several ways, including more efficient call scheduling, better agent utilization, and increased customer satisfaction. Further, agents may be provided customer specific insights and predictors from the personalization platform 1005 before a scheduled interaction to increase the likelihood of success.

In accordance with exemplary embodiments, agents may further be provided with dynamic personalized pricing and negotiation insights in relation to a particular customer. To explain this better, consider a sales and marketing use case in which agents are selling holiday packages to prospective customers as part of an outbound campaign. The personalization platform 1005 is able to predict the likely price that a given customer would be willing to pay and how much can be negotiated based on that customer's transaction history and/or the transaction histories of associated customers. To allow this sort of functionality, the enterprise will be requested to include as part of the enterprise campaign dataset 1020 information related to product pricing, marginal profit, or a range of acceptable process expected from sales, thereby allowing agents the ability to negotiate with customers in ways that are specific to individual customers.

In accordance with exemplary embodiments, channel specific enrichment may also be provided within the enriched campaign data set Channel specific content personalization algorithms may provide this, for example, by using the customer profiles (personal and past interaction data) as well as interactions of associated customers. Such channel data may include a most favored channel for reaching a particular customer as well as a next best channel. As part of the enriched campaign data set, the personalization platform 1005 may also provide the priority, time, and marketing content that is personalized for each customer across each of the available channels. From there, the outbound campaign server 1010 may include logic for implementing such strategies, for example, when to retry reaching a customer after a failure over a particular channel and what channel should be used for the next attempt.

The personalized content provided by the present systems and methods may range from content insights for voice calls, email, sms, social media post, advertisements, etc. For example, advertisements may include images or video messages that are personalized in relation to individual customers. With all content, the personalization platform 1005 may provide insights as to when and where it should be used so to improve the likelihood of success.

As stated, the present systems and methods may also provide campaign specific enrichment. This may include insights and predictions for the entire campaign so that a whole picture is developed toward a successful outcome. For example, extra capabilities for the outbound campaign may be provided for making decisions as to the success or failure of the campaign calls. These may be used to provide distinguishing aspect for evaluation for the campaign server 1010 between that which is expected (by the personalization platform 1005) and the results that are actually being achieved.

Ultimately, the enterprise will use the enriched campaign dataset 1030 provided by the personalization platform 1005 to implement an outbound campaign in ways that should lead to more success. As described, the enriched campaign dataset 1030 may include a customer list that has been augmented with predictors and insights that can be used to personalize the approach made to each customer in ways that increase the chance of success.

### Personalization Platform for Assisting Customers

Another aspect of the personalization platform 1005 is the manner in which it may assist customers. This includes the various ways of personalization that it enables on the customer side of the equation. As will be seen, customer side functionality may be implemented via data received from enterprises through the personalization platform 1005 and a mobile application running on a customer's personal device, which may be referred as a “personal bot”. For example, when enterprises send offers to customers as part of outbound campaigns, the personal bot 405 becomes a new endpoint for receiving that data and selectively presenting it to the customer. This functionality is bolstered by the personalization platform 1005, which uses insights gained from the stored customer's profiles to filter and classify those offers so that the personal bot 405 can more effectively serve as an intelligent offer “gate keeper” in relation to the customer. In this way, the burden on customers not to miss those “Don't Miss” offers is significantly eased.

To do this, in accordance with exemplary embodiments, the personalization platform 1005 functions by scoring in real time each of the offers being made to the customer by enterprises. Such scores are customer specific and based on each customer's needs as derived from the customer's saved profile and past behavior.

In accordance with exemplary embodiments, the personal bot 405 enables customers to follow-up by creating asynchronous queries in response to received offers and notifications. The customer can reach out to the enterprise through their personal bot, thereby, initiating an asynchronous outbound interaction as a new trigger for further communication with an enterprise.

In accordance with exemplary embodiments, the personalization platform 1005 may be configured to assist a customer via the customer's personal bot 405 in several ways. As stated, personal bots 405 actually act as an endpoint or a first point of contact for enterprises trying to contact the customer. Thus, the multitude of offers and related campaign data that enterprises regularly dispense to the customer can be received by the personal bot 405 and/or the personalization platform 1005. In accordance with exemplary embodiments, the personalization platform 1005 may filter, classify, prioritize, and score such offers and notifications that are intended for a customer. Such may be done in accordance with the saved profile of the particular customer along with insights or predictors derived by the personalization platform 1005 from customers associated with the customers, i.e., the aforementioned “associated customers”.

In accordance with exemplary embodiments, the personalization platform 1005 forms an understanding as to the customer's expectations and preferences in regard to the types of offers the customer wants to receive. Outbound communications from enterprises often reach out to the customers as email, SMS, chat, mms, or voice calls. However, for the customers, it is burdensome to access each of these different endpoints as they have to access each of the different applications. Eventually this causes the customer to miss offers from enterprises that they actual have an interested in. For example, an enterprise may fail in using the right channel to contact a particular customer. In accordance with exemplary embodiments, the personal bot 405 can prevent this eventuality by providing a single place for safely maintaining all such received offers and notifications outbound messages, notifications, offers, or deals intended for the customer by various enterprises.

In accordance with exemplary embodiments, the personalization platform 1005 may filter and push certain offers and notifications to the personal bot 405 of a customer in certain defined ways. For example, specific preferences on the types of offers the customers wants to receive may be obtained by the personal bot 405 when the customer registers or configures the personal bot. Such preferences may be received later when the customer indicates a desire to provide them. Customer also may request for specific notifications or offers be delivered to their personal bots 405, who would then act as a personal assistant, i.e., contacting and obtaining the requested information from the respective enterprises. These requests may be defined as relating to a specific enterprise or several enterprises.

Further, in accordance with exemplary embodiments, the customer may create a query from their personal device that the personal bot 405 then sends to the personalization platform 1005. The personalization platform 1005 would then trigger an interaction with one or more enterprises relevant to the query, collect data from those enterprises, and then present a response via the personal bot 405 to the customer.

In accordance with exemplary embodiments, the personalization platform 1005 also may gather data from enterprises related to campaigns and other offers and then act as a filter as to which are presented to the customer via the personal bot. To do this, the personalization platform 1005 considers the profile of the customer as well as profiles of customers found to be related to that particular customer, i.e., the “associated customers” discussed above. In this way, the personalization platform 1005 can prioritize those offers that are most relevant and appropriate for a given customer. In accordance with exemplary embodiments, the personalization platform 1005 may rank such offers from highest priority to lowest priority. The personalization platform 1005 may then allow these to be presented to the customer by the personal bot 405 in accordance with that ranking. The entire list of offers also may be made available to the customer upon request. The personal bots 405 may also include functionality allowing the customer to custom sort the data and offers received according to selected criteria so that the customer has the ultimate choice for selecting those offers that best suit them. Such criteria may include price, percentage markdown, subject matter or context, enterprise, etc. Such actions, when taken by the customer, may be saved in the customer's profile for later use by the personalization platform 1005 in relation to what future offers are presented to the customer.

In accordance with exemplary embodiments, the personalization platform 1005 also may monitor the customer's saved profile data and make associations between the preferences, interests, and other characteristics with similar or associated customers.

In accordance with exemplary embodiments, the customer may be notified of offers, deals, and outbound campaigns via communications sent directly to the customer's personal device. Those communications may be presented to the customer via the personal bot.

In accordance with exemplary embodiments, long-term monitoring of a customer's interactions as recorded in that customer's saved profile may yield insights that are helpful in providing further services. For example, if a customer has been using a television subscription service for an extended period and recent interactions indicated that the customer is overspending or that a less expensive plan would meet the customer's needs, the personalization platform 1005 may be capable of mining interaction data of other customers with same or similar subscription services and triggering notifications on what subscription package may be more suitable to the customer. Thus, based on interaction history and gained insights, the personalization platform 1005 may keep improving its knowledge of a particular customer and their expectations, needs, behavior, and preferences and, from this, improve upon its ability to proactively present offers to the customer that the customer finds highly relevant.

In accordance with exemplary embodiments, the personalization platform 1005 may classify all outbound notifications and offers made by enterprises. Then the interest or requests or triggers based on observed behavior are expressed or analyzed by the personalization platform 1005 and, thereby, used to enable an effective filter for selectively presenting those offers and notifications that are relevant and/or timely. With such filtration, the customer is regularly presented with those offers of particular relevance and becomes confident that they are not missing out on deals that are particularly well suited for them. From the perspective of the enterprise, the result is that customers that are well suited for a particular offer are likely to receive it. Further, once received, a customer is provided the choice to either act upon an offer immediately or can act upon it later when they have more time.

In accordance with exemplary embodiments, upon reviewing offers, the personal bot 405 is configured to interact with a particular enterprise and/or contact center or initiate an interaction therewith on receiving an indication from the customer that such action is desired. Further, the personalization platform 1005 allows the customer to use the campaign data to get immediately response to enterprises as desired and in a variety of ways. That is, the customer can use controls provided by personal bot 405 mobile application adjacent to the campaign data to respond to or communicate with enterprises across any of the available media channels, as may be desired by the customer. The interaction that the customer triggers from the campaign data will reach the appropriate enterprise with the correct details via the personalization platform 1005. Such interactions can also be multimedia enabled asynchronous queries, where customers are allowed to annotate or talk over the received offer/deal and then send that annotated material to the respective contact center or enterprise. In this way, a highly efficient way for the customer to send specific inquiries is enabled. The response from the enterprise is then routed via the personalization platform 1005 to the personal bot, which then presents it in a desired format to the customer.

In accordance with exemplary embodiments, the personal bot 405 generally displays to the customer information on offers received from the personalization platform 1005, which the personalization platform 1005 previously received from one or more enterprises. Again, the personal bot 405 may receive a request to initiate interaction from the customer and then forward that request to the personalization platform 1005, which in turn may asynchronously send the request to respective enterprises or can initiate a synchronous interaction between the customer and an agent. The personal bot 405 will include a query creation tool which has drawing controls and/or recording controls, which allows the customer to efficiently create asynchronous queries using media or materials received as part of the offer.

In accordance with exemplary embodiments, the personal bots 405 may include functionality that makes outbound campaigns more attractive and informative by allowing agents and customers to experience an outbound campaign as part of a multi-model process. When an agent interacts with the customer, for example, the offer may be displayed in any media format, with customers spending their time efficiently clearing up any questions and doubts that they may have, while agents concentrate on answering such questions and doubts and further explaining the offer. Even a simple voice interaction can be converted to a multi-modal outbound engagement by adding text, images, or video campaign data via functionality of the personal bots 405.

In accordance with exemplary embodiments, a personal bot 405 may be configured to intelligently identify the particular deal that a customer and agent are currently discussing from an offer basket maintained as part of the mobile application. Upon identifying the particular deal, the personal bot 405 may display visual information about the deal to the customer on the customer's personal device in real time as the conversation continues and, thereby, assist the customer in having a meaningful interaction that addresses each of the questions that they have. Further, since the personal bot 405 includes functionality allowing it to listen to all voice received interactions from the enterprise, certain functionality may allow the campaign to receive more quantifiable results instantly during the interaction itself.

In accordance with exemplary embodiments, with all the above capabilities, the digital assistant services offered by the personal bot 405 may help the customer better analyze offers across different media channels and, ultimately, allow the customer to make decisions that are better informed. For example, when a customer is viewing an offer in the personal bot 405 mobile application, the personalization platform 1005 may be able to add insights relevant to the deal in real time, like “This package is generally sells for between $50 and $60” or “The best time to book a room in this hotel is on a Tuesday morning when prices are at their lowest”. When the agent is talking to a customer about an offer, the personalization platform 1005 can instruct the personal bot 405 to display a pop-up screen with such personalized add-ons and suggestions relevant to negotiating the best outcome. In this way, the personalization platform 1005 builds a pricing and negotiation model with the enterprise's data as well as data associated with interactions other customers had with the same or different enterprises. With all these associations, the personalization platform 1005 can effectively instruct the personal bot 405 in ways to assist the customer in reaching the most favorable outcome.

In accordance with exemplary embodiments, once the personalization platform 1005 become aware that a particular customer is going to receive an offer from a particular enterprise in a specified context, the personalization platform 1005 may enable functionality that includes sending a topical push notification to the customer through the personal bot 405 that informs the customer as to the coming offer. Such push notifications may enable several advantages. For example, customers will know the reason for an incoming call from a particular enterprise before answering. Knowing the reason for the incoming call and that it involves a special offer for the customer may improve the likelihood of the customer taking the call and speaking with the agent. That is, when the customer needs something and knows that an incoming call relates to that need, there an increased chance that the customer speaks with the agent, which can significantly improve the success rate of the campaign. Further, the call may be timed more effectively if it is placed in relation to an indication by the personal bot 405 that the customer has actually seen or read the push notification.

Aspects of the present invention also may enable the more effective analysis of many of the failures associated with outbound campaigns. For example, if a customer fails to take a call related to an outbound campaign, information collected by the personal bot 405 may assist in explaining why this occurred. Activity on the customers personal device may indicate that the customer was busy when the call occurred and so could not engage at that time. Such knowledge may allow a follow-up push notification informing the customer that another call could be placed at a time of the customer's choosing. If the customer is not interested in scheduling a later call, this can provide valuable feedback as it indicates that the customer is not interested in the subject matter of the offer. Such knowledge can enable the outbound campaign to move forward without wasting further effort on that customer. Further, that information can inform actions of future campaigns in relation to the interests of that particular customer.

In accordance with exemplary embodiments, the personal bot 405 may also include functionality for providing personalized advertisement content, for example, while at a customer is on hold or waiting to be connected to an agent. Especially in the context of outbound calls, personalized advertisements can be posted as video/personalized messages before the customer is connected with an agent. If the customer finds such personalized content interesting, it has been found to significantly increase the customer's ability to tolerate longer wait periods. The personalized content, of course, also serves as an additional marketing opportunity for products. Using AI, the personalization platform 1005 may be able to tailor such advertisements and content to a particular customer's interests. This may be accomplished through analysis of the stored profile data for the particular customer or from associations made with associated customers. The customers reactions to and interactions with the personalized advertisements may be recorded via the personal bot 405 and communicated to the personalization platform 1005. This new data may form the basis for more accurate predictions in relation to the preferences and dislikes of that particular customer and, for example, may form the basis for personalizing future outbound campaigns. As will be appreciated, similar practices may be applied for holds occurring during a customer-initiated call to an enterprise.

With reference now to FIG. 15, an exemplary method of the present invention will now be described. The method may relate to implementing an outbound campaign of an enterprise in which an offer is communicated to target customers in a manner that is personalized for each of the target customers. When exemplified in relation to a first one of the target customers (hereinafter “first target customer”) in a manner representative of how the communication of the offer is personalized for each of the target customers, the method may include the following steps. At step 1105, a customer profile database may be provided. The customer profile database may store a customer profile of the first target customer and customer profiles of respective other customers. A personalization platform also may be provided. The personalization platform may include an intermediary entity that is separate (for example, legally separate) from both the first target customer and the enterprise. The personalization platform may include access to the customer profiles stored in the customer profile database. At step 1110, the customer profile of the first target customer according to data received from a personal assistant bot application (hereafter “personal bot”) running on a personal communication device of the first target customer. The personal bot may be configured to update the customer profile of the first target customer by collecting interaction data describing interactions conducted by the first target customer via the personal communication device with other enterprises. At step 1115, interaction predictors relating to the first target customer may be derived. Each one of the interaction predictors may include knowledge about the first target customer. The knowledge may describe a behavioral tendency attributable to the first target customer for given a type of interaction. The derivation of the interaction predictors may be based on one or both of the following: a behavioral tendency exhibited by the first target customer given the interaction data stored in the customer profile of the first target customer; and a behavioral tendency exhibited by a group of the other customers given interaction data stored in the customer profiles that describes interactions that occurred between the other customers and the other enterprises, wherein the first target customer is found to have a characteristic common to the group of the other customers and wherein the characteristic is found to be correlate with the behavioral tendency. At step 1120, the personalization platform may receive an enterprise campaign dataset from the enterprise related to the outbound campaign. The enterprise campaign dataset may include information describing the offer and a context of the outbound campaign and a list of the target customers. At step 1125, the personalization platform may augment the enterprise campaign dataset with one or more of the interaction predictors related to the first target customer to produce an enriched campaign dataset. This, for example, may be done by selecting one or more of the interaction predictors (hereafter “selected interaction predictors”) based on a relevance to the context of the outbound campaign and then including, in the enriched campaign dataset, the selected interaction predictors as data linked to and describing the first target customer. At step 1130, the method may come to an end as the personalization platform transmits the enriched campaign dataset to the enterprise for use thereby in implementing the outbound campaign.

In accordance with an exemplary embodiment, a more-detailed enumeration of one or more of the steps may include applying a machine learning algorithm across the interaction data of both the first target customer and the other customer to identify patterns correlating one or more factors to a desired outcome given the type of interaction.

In accordance with an exemplary embodiment, the customer profile of the first target customer and the customer profiles of the other customers may include biographical personal data relating to the first customer and the other customers, respectively. The characteristic common to the group of the other customers may include a characteristic stored within the biographical personal data.

In accordance with an exemplary embodiment, the personal bot may be configured to update the customer profile of the first target customer via performing a first subprocess to collect the interaction data. The first subprocess may be performed repetitively so to update the customer profile of the first target customer after each successive one of the interactions. Described in relation to an exemplary first one of the interactions (hereinafter “first interaction”) between the first target customer and a first one of the other enterprises (hereinafter “first other enterprise”), the first subprocess may include the steps of: monitoring activity on the personal communication device and, therefrom, detecting activity indicating occurrence of the first interaction with the first other enterprise; identifying data relating to the first interaction for collecting as the interaction data; and transmitting to the customer profile database the collected interaction data relating to the first interaction.

In accordance with an exemplary embodiment, the enterprise campaign dataset further may include media channel information describing one or more media channels over which the enterprise intends to communicate the offer to the first target customer during the outbound campaign. The selected interaction predictors included in the enriched campaign dataset may include knowledge about the first target customer describing a preference of the first target customer in regard to receiving communications over the one or more media channels.

In accordance with an exemplary embodiment, the selected interaction predictors included in the enriched campaign dataset may include knowledge about the first target customer describing: a favored media channel for the first target customer to receive the offer; and a favored time of day for increasing a likelihood of connecting with the first target customer over the favored media channel.

In accordance with an exemplary embodiment, the enterprise campaign dataset further may include media channel information describing a plurality of media channels over which the enterprise intends to communicate the offer to the first target customer during the outbound campaign. The selected interaction predictors included in the enriched campaign dataset may include knowledge about the first target customer describing a predicted success rate for each of the plurality of media channels. The predicted success rate may indicate a predicted likelihood of the first target customer accepting the offer when the offer is communicated using a given one of the plurality of media channels.

In accordance with an exemplary embodiment, the enterprise campaign dataset further may include a plurality of upselling and cross-selling opportunities related to the offer. The selected interaction predictors included in the enriched campaign dataset may include knowledge about the first target customer describing an interest of the first target customer related to at least one of the upselling and cross-selling opportunities. The selected interaction predictors included in the enriched campaign dataset may include knowledge about the first target customer indicating a favored one of the upselling and cross-selling opportunities in terms of a likelihood of success with the first target customer.

In accordance with an exemplary embodiment, the enterprise campaign dataset further may include data indicating a range of pricing terms acceptable to the enterprise as payment for the offer. The selected interaction predictors included in the enriched campaign dataset may include knowledge about the first target customer describing a comparison of a likelihood of the first target customer accepting the offer between at least two different pricing levels defined within the range of pricing terms. The selected interaction predictors included in the enriched campaign dataset may include knowledge about the first target customer describing a favored personalized media content for including in the offer to the first target customer.

In accordance with an exemplary embodiment, the enterprise campaign dataset further may include data regarding agent profiles for respective agents identified by the enterprises as available to communicate the offer to the target customers during the outbound campaign. The selected interaction predictors included in the enriched campaign dataset may include knowledge about the first target customer describing: a favored one or more of the agents for communicating the offer to the first target customer; and/or a matching of the first target customer to a favored one of the agents.

In accordance with an exemplary embodiment, the enterprise campaign dataset further may include data regarding agent profiles for respective agents identified by the enterprises as available to communicate the offer to the target customers during the outbound campaign. The selected interaction predictors included in the enriched campaign dataset may include knowledge about the first target customer describing: a matching of the first target customer to a favored one of the agents; a favored media channel for the first target customer to receive the offer; and a favored time of day for increasing a likelihood of connecting with the first target customer over the favored media channel. The enriched campaign dataset may further include a work schedule scheduling hours that the favored one of the agents will work during the outbound campaign based on: the favored time of day for connecting with the first target customer; and a favored time of day for connecting with at least one other of the target customers that is also matched to the favored one of the agents.

In accordance with an exemplary embodiment, the selected interaction predictors included in the enriched campaign dataset may include knowledge about the first target customer describing a patience scored and/or a predicted handle time. The patience score may indicate a tendency of the first target customer to tolerate hold times exceeding a predetermined length. The predicted handle time may indicate an anticipated length to handle an interaction with the first target customer given the context of the outbound campaign.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof

That which is claimed:

1. A computer-implemented method related to implementing an outbound campaign of an enterprise in which an offer is communicated to target customers in a manner that is personalized for each of the target customers, wherein, when exemplified in relation to a first one of the target customers (hereinafter “first target customer”) in a manner representative of how the communication of the offer is personalized for each of the target customers, the method comprises:
providing a customer profile database, the customer profile database storing a customer profile of the first target customer and customer profiles of respective other customers;
providing a personalization platform, the personalization platform comprising an intermediary entity that is separate from both the first target customer and the enterprise, wherein the personalization platform comprises access to the customer profiles stored in the customer profile database;
updating the customer profile of the first target customer according to data received from a personal assistant bot application (hereafter “personal bot”) running on a personal communication device of the first target customer, wherein the personal bot is configured to update the customer profile of the first target customer by collecting interaction data describing interactions conducted by the first target customer via the personal communication device with other enterprises;
deriving interaction predictors, each one of the interaction predictors comprising knowledge about the first target customer, the knowledge describing a behavioral tendency attributable to the first target customer for given a type of interaction, wherein the derivation of the interaction predictors is based on at least one of:
a behavioral tendency exhibited by the first target customer given the interaction data stored in the customer profile of the first target customer; and
a behavioral tendency exhibited by a group of the other customers given interaction data stored in the customer profiles that describes interactions that occurred between the other customers and the other enterprises, wherein the first target customer is found to have a characteristic common to the group of the other customers and wherein the characteristic is found to be correlate with the behavioral tendency;
receiving, at the personalization platform, an enterprise campaign dataset from the enterprise related to the outbound campaign, the enterprise campaign dataset comprising at least:
information describing the offer and a context of the outbound campaign; and
a list of the target customers;
augmenting, at the personalization platform, the enterprise campaign dataset with one or more of the interaction predictors related to the first target customer to produce an enriched campaign dataset by:
selecting the one or more of the interaction predictors (hereafter “selected interaction predictors”) based on a relevance to the context of the outbound campaign; and
including, in the enriched campaign dataset, the selected one or more interaction predictors as data linked to and describing the first target customer; and
transmitting, from the personalization platform, the enriched campaign dataset to the enterprise for use thereby in implementing the outbound campaign.

2. The computer-implemented method of claim 1, wherein the derivation of the interaction predictors is based on both:
the behavioral tendency exhibited by the first target customer given the interaction data stored in the customer profile of the first target customer; and
the behavioral tendency exhibited by the group of the other customers given the interaction data describing the interactions that occurred between the other customers and the other enterprises.

3. The computer-implemented method of claim 2, wherein a more-detailed enumeration of one or more of the steps includes: applying a machine learning algorithm across the interaction data of both the first target customer and the other customer to identify patterns correlating one or more factors to a desired outcome given the type of interaction.

4. The computer-implemented method of claim 2, wherein the customer profile of the first target customer and the customer profiles of the other customers include biographical personal data relating to the first customer and the other customers, respectively; and
wherein the characteristic common to the group of the other customers comprise a characteristic stored within the biographical personal data.

5. The computer-implemented method of claim 2, wherein the personal bot is configured to update the customer profile of the first target customer via performing a first subprocess to collect the interaction data, the first subprocess being performed repetitively so to update the customer profile of the first target customer after each successive one of the interactions, wherein, described in relation to an exemplary first one of the interactions (hereinafter “first interaction”) between the first target customer and a first one of the other enterprises (hereinafter “first other enterprise”), the first subprocess includes the steps of:
monitoring activity on the personal communication device and, therefrom, detecting activity indicating occurrence of the first interaction with the first other enterprise;
identifying data relating to the first interaction for collecting as the interaction data; and
transmitting to the customer profile database the collected interaction data relating to the first interaction.

6. The computer-implemented method of claim 1, wherein the enterprise campaign dataset further comprises media channel information describing one or more media channels over which the enterprise intends to communicate the offer to the first target customer during the outbound campaign; and
wherein the selected interaction predictors included in the enriched campaign dataset comprise knowledge about the first target customer describing:
a preference of the first target customer in regard to receiving communications over the one or more media channels.

7. The computer-implemented method of claim 1, wherein the selected interaction predictors included in the enriched campaign dataset comprise knowledge about the first target customer describing:
a favored media channel for the first target customer to receive the offer; and
a favored time of day for increasing a likelihood of connecting with the first target customer over the favored media channel.

8. The computer-implemented method of claim 1, wherein the enterprise campaign dataset further comprises media channel information describing a plurality of media channels over which the enterprise intends to communicate the offer to the first target customer during the outbound campaign; and
wherein the selected interaction predictors included in the enriched campaign dataset comprise knowledge about the first target customer describing:
a predicted success rate for each of the plurality of media channels, the predicted success rate indicating a predicted likelihood of the first target customer accepting the offer when the offer is communicated using a given one of the plurality of media channels.

9. The computer-implemented method of claim 1, wherein the enterprise campaign dataset further comprises a plurality of upselling and cross-selling opportunities related to the offer; and
wherein the selected interaction predictors included in the enriched campaign dataset comprise knowledge about the first target customer describing:
an interest of the first target customer related to at least one of the plurality of upselling and cross-selling opportunities.

10. The computer-implemented method of claim 9, wherein the selected interaction predictors included in the enriched campaign dataset comprise knowledge about the first target customer indicating:
a favored one of the plurality of upselling and cross-selling opportunities in terms of a likelihood of success with the first target customer.

11. The computer-implemented method of claim 1, wherein the enterprise campaign dataset further comprises data indicating a range of pricing terms acceptable to the enterprise as payment for the offer; and
wherein the selected interaction predictors included in the enriched campaign dataset comprise knowledge about the first target customer describing:
a comparison of a likelihood of the first target customer accepting the offer between at least two different pricing levels defined within the range of pricing terms.

12. The computer-implemented method of claim 1, wherein the selected interaction predictors included in the enriched campaign dataset comprise knowledge about the first target customer describing:
a favored personalized media content for including in the offer to the first target customer.

13. The computer-implemented method of claim 1, wherein the enterprise campaign dataset further comprises data regarding agent profiles for respective agents identified by the enterprises as available to communicate the offer to the target customers during the outbound campaign; and
wherein the selected interaction predictors included in the enriched campaign dataset comprise knowledge about the first target customer describing:
a favored one or more of the agents for communicating the offer to the first target customer.

14. The computer-implemented method of claim 1, wherein the enterprise campaign dataset further comprises data regarding agent profiles for respective agents identified by the enterprises as available to communicate the offer to the target customers during the outbound campaign; and
wherein the selected interaction predictors included in the enriched campaign dataset comprise knowledge about the first target customer describing:
a matching of the first target customer to a favored one of the agents.

15. The computer-implemented method of claim 1, wherein the enterprise campaign dataset further comprises data regarding agent profiles for respective agents identified by the enterprises as available to communicate the offer to the target customers during the outbound campaign; and
wherein the selected interaction predictors included in the enriched campaign dataset comprise knowledge about the first target customer describing:
a matching of the first target customer to a favored one of the agents;
a favored media channel for the first target customer to receive the offer; and
a favored time of day for increasing a likelihood of connecting with the first target customer over the favored media channel;
wherein the enriched campaign dataset further comprises a work schedule scheduling hours that the favored one of the agents will work during the outbound campaign based on: the favored time of day for connecting with the first target customer; and a favored time of day for connecting with at least one other of the target customers that is also matched to the favored one of the agents.

16. The computer-implemented method of claim 1, wherein the selected interaction predictors included in the enriched campaign dataset comprise knowledge about the first target customer describing at least one of:
a patience scored, wherein the patience score indicates a tendency of the first target customer to tolerate hold times exceeding a predetermined length; and
a predicted handle time, wherein the predicted handle time indicates an anticipated length to handle an interaction with the first target customer given the context of the outbound campaign.

17. A system related to implementing an outbound campaign of an enterprise in which an offer is communicated to target customers in a manner that is personalized for each of the target customers, the system comprising:
a hardware processor; and
a machine-readable storage medium on which is stored instructions that cause the hardware processor to execute a process, wherein the process comprises the steps of:
providing a customer profile database, the customer profile database storing a customer profile of the first target customer and customer profiles of respective other customers;
providing a personalization platform, the personalization platform comprising an intermediary entity that is separate from both the first target customer and the enterprise, wherein the personalization platform comprises access to the customer profiles stored in the customer profile database;
updating the customer profile of the first target customer according to data received from a personal assistant bot application (hereafter “personal bot”) running on a personal communication device of the first target customer, wherein the personal bot is configured to update the customer profile of the first target customer by collecting interaction data describing interactions conducted by the first target customer via the personal communication device with other enterprises;
deriving interaction predictors, each one of the interaction predictors comprising knowledge about the first target customer, the knowledge describing a behavioral tendency attributable to the first target customer for given a type of interaction, wherein the derivation of the interaction predictors is based on at least one of:
a behavioral tendency exhibited by the first target customer given the interaction data stored in the customer profile of the first target customer; and
a behavioral tendency exhibited by a group of the other customers given interaction data stored in the customer profiles that describes interactions that occurred between the other customers and the other enterprises, wherein the first target customer is found to have a characteristic common to the group of the other customers and wherein the characteristic is found to be correlate with the behavioral tendency;
receiving, at the personalization platform, an enterprise campaign dataset from the enterprise related to the outbound campaign, the enterprise campaign dataset comprising at least:
information describing the offer and a context of the outbound campaign; and
a list of the target customers;
augmenting, at the personalization platform, the enterprise campaign dataset with one or more of the interaction predictors related to the first target customer to produce an enriched campaign dataset by:
selecting the one or more of the interaction predictors (hereafter “selected interaction predictors”) based on a relevance to the context of the outbound campaign; and
including, in the enriched campaign dataset, the selected one or more interaction predictors as data linked to and describing the first target customer; and
transmitting, from the personalization platform, the enriched campaign dataset to the enterprise for use thereby in implementing the outbound campaign.

18. The system of claim 17, wherein the derivation of the interaction predictors comprises applying a machine learning algorithm across the interaction data of both the first target customer and the other customer to identify patterns correlating one or more factors to a desired outcome given the type of interaction;
wherein the enterprise campaign dataset further comprises media channel information describing one or more media channels over which the enterprise intends to communicate the offer to the first target customer during the outbound campaign; and
wherein the selected interaction predictors included in the enriched campaign dataset comprise knowledge about the first target customer describing:
a preference of the first target customer in regard to receiving communications over the one or more media channels.

19. The system of claim 17, wherein the selected interaction predictors included in the enriched campaign dataset comprise knowledge about the first target customer describing:
a favored media channel for the first target customer to receive the offer; and
a favored time of day for increasing a likelihood of connecting with the first target customer over the favored media channel.

20. The system of claim 17, wherein the enterprise campaign dataset further comprises media channel information describing a plurality of media channels over which the enterprise intends to communicate the offer to the first target customer during the outbound campaign; and
wherein the selected interaction predictors included in the enriched campaign dataset comprise knowledge about the first target customer describing:
a predicted success rate for each of the plurality of media channels, the predicted success rate indicating a predicted likelihood of the first target customer accepting the offer when the offer is communicated using a given one of the plurality of media channels.

21. The system of claim 17, wherein the enterprise campaign dataset further comprises data indicating a range of pricing terms acceptable to the enterprise as payment for the offer; and
wherein the selected interaction predictors included in the enriched campaign dataset comprise knowledge about the first target customer describing:
a comparison of a likelihood of the first target customer accepting the offer between at least two different pricing levels defined within the range of pricing terms.

22. The system of claim 17, wherein the selected interaction predictors included in the enriched campaign dataset comprise knowledge about the first target customer describing:
a favored personalized media content for including in the offer to the first target customer.

23. The system of claim 17, wherein the enterprise campaign dataset further comprises data regarding agent profiles for respective agents identified by the enterprises as available to communicate the offer to the target customers during the outbound campaign; and
wherein the selected interaction predictors included in the enriched campaign dataset comprise knowledge about the first target customer describing:
a favored one or more of the agents for communicating the offer to the first target customer.

24. The system of claim 17, wherein the enterprise campaign dataset further comprises data regarding agent profiles for respective agents identified by the enterprises as available to communicate the offer to the target customers during the outbound campaign; and
wherein the selected interaction predictors included in the enriched campaign dataset comprise knowledge about the first target customer describing:
a matching of the first target customer to a favored one of the agents.

25. The system of claim 17, wherein the selected interaction predictors included in the enriched campaign dataset comprise knowledge about the first target customer describing at least one of:
a patience scored, wherein the patience score indicates a tendency of the first target customer to tolerate hold times exceeding a predetermined length; and
a predicted handle time, wherein the predicted handle time indicates an anticipated length to handle an interaction with the first target customer given the context of the outbound campaign.
